(19) United States
(12) Patent Application Publication
(10) Pub. No.: US 2026/0277245 A1
(43) Pub. Date: Sep. 17, 2026

(54) METHODS AND APPARATUS FOR TRACKING WITH OCCLUSIONS

(71) Applicant: Insitu, Inc., A Subsidiary of the Boeing Company, Bingen, WA (US)

(72) Inventors: Rolf Theodoor Rysdyk, Hood River, OR (US); David Matthew Ingraham, White Salmon, WA (US); Scott Patrick Marmillion, White Salmon, WA (US)

(21) Appl. No.: 19/077,890

(22) Filed: Mar. 12, 2025

(51) Int. Cl. G05D 1/689; B64D 7/00; G05D 105/85; G05D 109/22

(52) U.S. Cl. CPC G05D 1/689; B64D 7/00; G05D 2105/85; G05D 2109/22

(57) ABSTRACT

Methods and apparatus for tracking with occlusions are disclosed. A disclosed example apparatus includes interface circuitry communicatively coupled to an aiming device and an image sensor carried by an aircraft, machine-readable instructions, and at least one processor circuit to be programmed by the machine-readable instructions to determine that a target has been occluded as the image sensor is directed toward the target via the aiming device to track the target, determine, in response to the target being occluded, orientations of the image sensor during tracking of the target, and determine an estimated position of the target based on navigation information of the aircraft and the orientations for directing the aiming device during the occlusion of the target.

### FIELD OF THE DISCLOSURE

This disclosure relates generally to navigation and, more particularly, to methods and apparatus for tracking with occlusions.

### BACKGROUND

Aircraft, such as fixed wing aircraft, can track a target with a payload for positioning information. However, brief target occlusions can occur. In particular, parts of the aircraft may occlude the target from the payload when the aircraft is maneuvering. For example, when a lock on the target is lost (e.g., a wing of the aircraft occludes the payload) a source of the aforementioned positioning information may be lost.

### SUMMARY

A disclosed example apparatus includes interface circuitry communicatively coupled to an aiming device and an image sensor carried by an aircraft, machine-readable instructions, and at least one processor circuit to be programmed by the machine-readable instructions to determine that a target has been occluded as the image sensor is directed toward the target via the aiming device to track the target, determine, in response to the target being occluded, orientations of the image sensor during tracking of the target, and determine an estimated position of the target based on flight sensor information of the aircraft and the orientations for directing the aiming device during the occlusion of the target. As a result, examples disclosed herein can utilize the estimated position to track the target even when the target is occluded.

An example of at least one non-transitory machine-readable medium includes machine-readable instructions to cause at least one processor circuit to at least determine that a target has been occluded as an image sensor of an aircraft is directed toward the target via an aiming device to track the target, determine, in response to the target being occluded, orientations of the image sensor during tracking of the target, and determine an estimated position of the target based on flight sensor information of the aircraft and the orientations for directing the aiming device during the occlusion of the target.

An example method includes determining, by at least one processor circuit programmed by at least one instruction that a target has been occluded as an image sensor of an aircraft is directed toward the target via an aiming device to track the target, in response to the target being occluded, determining, by one or more of the at least one processor circuit, orientations of the image sensor during tracking of the target, and determining, by one or more of the at least one processor circuit, an estimated position of the target based on flight sensor information of the aircraft and the orientations for directing the aiming device during the occlusion of the target.

### BRIEF DESCRIPTION OF THE DRAWINGS

FIG. 1A illustrates an example aircraft in which examples disclosed herein can be implemented.

FIG. 1B illustrates occlusions that can occur during tracking.

FIG. 2A illustrates an example process flow of a closed loop targeting architecture in accordance with teachings of this disclosure.

FIG. 2B illustrates an example synthetic image that can be implemented in examples disclosed herein.

FIGS. 3 and 4 illustrate example results that can be obtained with examples disclosed herein.

FIG. 5 illustrates an example process flow of an image-based range estimator that can be implemented in examples disclosed herein.

FIG. 6 illustrates an example notional aspect of an estimation problem.

FIGS. 7A-7C illustrate example aspects of scaling that can be implemented in examples disclosed herein.

FIG. 8 illustrates aspects of a formal observability condition with respect to examples disclosed herein.

FIG. 9 illustrates an example orbit.

FIG. 10 illustrates rate estimation corresponding to example orbit of FIG. 9.

FIG. 11 illustrates an example standoff maneuver.

FIG. 12 illustrates rate estimation performance corresponding to the example standoff maneuver shown in FIG. 11.

FIG. 13 illustrates an example result of wing occlusion in a high wind condition.

FIG. 14 is a block diagram of an example payload orientation analysis system that can be implemented in examples disclosed herein.

FIG. 15 is a flowchart representative of example machine readable instructions and/or example operations that may be executed, instantiated, and/or performed by example programmable circuitry to implement the example payload orientation analysis system of FIG. 15.

FIG. 16 is a block diagram of an example processing platform including programmable circuitry structured to execute, instantiate, and/or perform the example machine readable instructions and/or perform the example operations of FIG. 15 to implement the payload orientation analysis system of FIG. 14.

FIG. 17 is a block diagram of an example implementation of the programmable circuitry of FIG. 16.

FIG. 18 is a block diagram of another example implementation of the programmable circuitry of FIG. 16.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus for navigation based on tracking orientation are disclosed. The feasibility of turret-based navigation and guidance was recently demonstrated in flight on a routine mission-task. A payload orientation, such as an orientation of a turret or camera, relative to an aircraft/aerial vehicle (AV) is fully defined with at least two angles, which may be used to guide the aircraft towards a target when the payload is image-stabilized on that target. Image-stabilization typically includes a combination of inertial sensors and image processing. Further, gyroscopes provide rate information that is compensated for with electronic gimbals, and disturbances in camera field-of-view are corrected in substantially real-time with relatively common image-processing techniques.

According to examples disclosed herein, known and/or determined payload angles can be utilized in conjunction with an aerial vehicle (AV) orientation in an estimator which can provide both navigation information and wind estimates. With navigation and wind estimates available, most conventional guidance laws may be used to stabilize the aircraft along a desired path. Furthermore, according to examples disclosed herein, when the image is temporarily obscured or occluded, the same kinematics may be used to provide a dead-reckoning estimate of AV navigation, its payload orientation, and the screen coordinates of the target.

Examples disclosed herein can guide an aircraft with stabilized motion utilizing payload orientation. Furthermore, if the aircraft heading is known, wind conditions can be estimated, and if the target global location is known a priori, the aircraft global location can be estimated. Wind can be significant in the operation of a relatively small unmanned aircraft system (UAS) vehicle, aerial vehicle, and/or aircraft and an estimate of the wind can be utilized to position an aircraft relative or other aerial vehicle to a target for improved orbit tracking.

In known implementations, the bearings-only localization problem is a traditional navigation challenge and has been studied from maritime settings to space-docking applications. Relatively recent work formalized stability characteristics in control theoretical terms with stability guarantees and conditions for observability. Observability can necessitate persistent maneuvering relative to a target, which can be difficult to satisfy in general. For example, typical aviation protocols, intelligence, surveillance, and reconnaissance (ISR) mission considerations, and vehicle performance do not make altitude changes readily possible and, thus, persistent excitation (PE) conditions are not always satisfied. It is therefore of interest to study the estimation problem in context of the mission scenario. For example, one way to satisfy PE conditions in known implementations is to reduce a navigation problem to a two-dimensional scenario and focus on close-in orbits around the target of interest. However, these known implementations avoid the question of how to navigate when remote from a target, and do not address altitude estimation. Further, wind being unknown can pose a challenge.

Robotics applications offer important examples of camera-based navigation and control. In particular, visual servoing is well established in dynamic robotics settings and may be utilized for guidance of small unmanned aerial vehicles (UAVs) or micro aerial vehicles (MAVs) via their payload imagery. Relying more explicitly on image-processing and utilizing screen coordinates in its dynamic state formulations, image-based visual servoing can offer alternative payload-based guidance advantages.

Position-based visual servoing derives position and orientation from the image, which is subsequently used for guidance and control. This offers the advantage of enabling traditional guidance laws but is known to be sensitive to model errors and camera calibration. Distinct drawbacks of such implementations include computational requirements, lack of robustness to disturbance, the fragile nature of the estimator, and the motion required for PE.

A low-computational processing example of vision-based guidance is demonstrated for a fixed-wing AV in orbit in known implementations. That work describes an imagery-derived relative-bearing based control method, capable of stabilizing a fixed wing AV in close-in orbit about the visual target. However, that work does not address the effect of wind. The image-based guidance is combined with a two-dimensional (2D) estimator for planar position and wind. The estimator in known implementations rely on reducing a bearing-only localization problem to two dimensions, and to ensure extended Kalman filter (EKF) consistency, it must be carefully tuned and initialized.

According to examples disclosed herein, a three-dimensional bearing-only design is implemented, where an additional degree of freedom is utilized to add significant robustness for mission scenarios. By taking advantage of a look-down angle in addition to the relative bearing, examples disclosed herein can enable effective operation of a simple controller and can further add altimetry to the estimator. The latter enables a significant relaxation of the PE requirement, provides the estimator with increased robustness at long distances, and supports long endurance missions.

A typical ISR mission task is to approach a remote target for observation with a camera payload. This involves an enroute phase to get to a general vicinity of a target, subsequently followed by a transition into orbit about the target or into a stand-off observation maneuver. Examples disclosed herein utilize bearing-only navigation principles to this task executed in the absence of global positioning signals. The choreography of the typical mission task can maximize target exposure and it is demonstrated that this also enables a navigation estimator. Examples disclosed herein add further robustness to the estimator by including barometric altitude information.

On typical aircraft, airspeed, attitude, and heading estimates are commonly available by utilizing readily available inertial measurement units (IMUs). These estimates are independent of global navigation satellite system (GNSS) signals, such as global positioning system (GPS) signals. However, wind information is important and is not generally available without GPS. Although not readily available, there are known methods found in robotics. With respect to aviation, however, some known implementations include: (i) a combination of optic flow with an estimation of range to target, and (ii) a combination of altimetry and bearing-only state estimation.

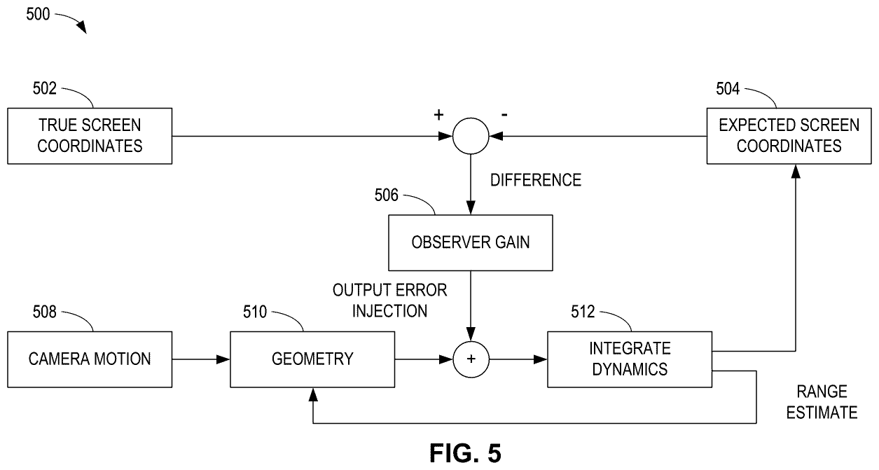

For optic flow with range finding, when orbiting a feature within the image, the distance to the feature can be estimated according to known implementations. This is an aspect used in the geometry-based structure from motion methods, in which range to observed objects is estimated from parallax after sufficient movement of the camera has occurred. Range is utilized for an interaction matrix. Even if a range-finding sensor can be used, the range estimator would work in concert, for example, as a Kalman filter, as shown below in connection with FIG. 5. This can be desirable when range measurements only occur at low rates.

Another vision-based algorithm that estimates range as well as wind-velocity without GNSS/GPS signals was demonstrated in a known implementation, such that it was demonstrated that wind is readily observed in orbiting scenarios when airspeed and heading is known, without necessitating sophisticated image-processing. However, that work did not indicate how wind should be used in design of guidance logic.

Bearings-only localization is a traditional navigation problem and has been well studied from maritime settings to space-docking applications. In known implementations, a combination of an extended Kalman filter with an ad-hoc algorithm formulated using polar-coordinates is utilized to isolate inertial dynamics from the air-relative motion once a range estimate is available. In some known implementations, Cartesian coordinates are favored where stability characteristics are concisely formalized in control theoretical terms, with stability guarantees and conditions for observability, which is generally regarded as the ability to estimate. Significantly, observability requires persistent maneuvering relative to the target, which can be difficult to satisfy for certain mission scenarios. Specifically, altitude changes are not readily possible. An estimator more amenable to those mission scenarios is feasible by adding altimetry, for example, as demonstrated in examples disclosed herein.

Examples disclosed herein enable a method that, in the absence of global positioning systems such as GPS, is capable of providing continued guidance to a fixed-wing aircraft (or other type of aircraft) and its payload orientation during brief target occlusions when target-lock is lost, like those associated with an aircraft wing occluding the payload image, and where target-lock is also the primary source for positioning information.

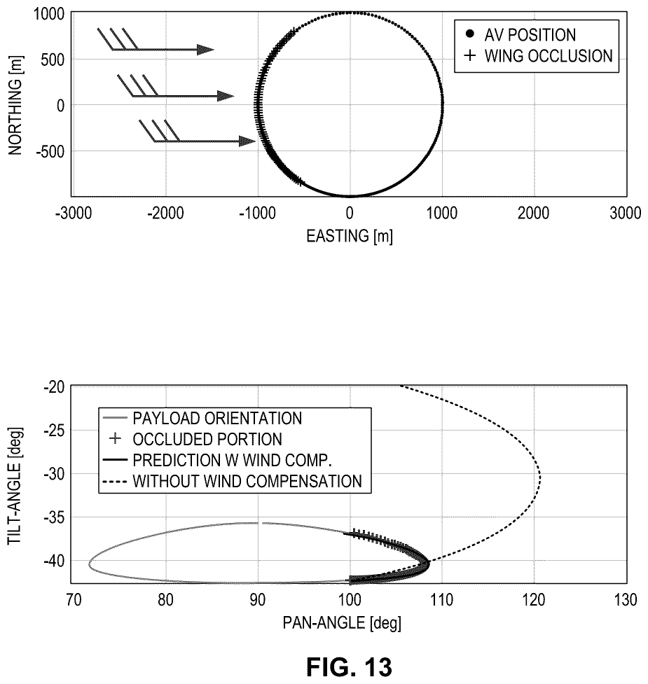

Examples disclosed herein enable: (i) logic with continued maneuvering relative to a target when target-lock is also the primary source for locating and orienting the vehicle (See example Equation 32 and FIG. 13 below); (ii) an associated estimator that also provides information that enables synthetic imagery for the scenery occluded by the wing, where the synthetic scenes can be used to provide continuity and aid situational awareness for an operator at the ground control station, for example; and (iii) results for the effects of wind such that the effects of the wind and that of a moving target can be similar or the same. As a result, examples disclosed herein can be applicable to tracking of a moving target (e.g., a moving ground target) as well as a stationary target.

Examples disclosed herein can utilize an estimate of wind (e.g., in the absence of GNSS/GPS signals). Relative motion can be estimated with respect to wind or a moving target, both of which can have a similar or same effect. Examples disclosed herein can utilize an estimate of navigation information.

Examples disclosed herein enable tracking of a target by an aircraft that is maneuvering relative thereto. Examples disclosed herein can advantageously enable tracking of the target even when the target is occluded. Examples disclosed herein determine that the target has been occluded (e.g., during tracking thereof). In response to the determination that the target is occluded, orientations of a payload (e.g., an image sensor) during tracking of the target are determined. According to examples disclosed herein, an estimated position (e.g., screen coordinate position) is determined as the target is occluded based on the orientations of the payload in conjunction with flight sensor information (e.g., altimetry data, barometric data, airdata, inertial data, speed information, etc.).

In some examples, a synthetic image is generated. In some such examples, a target or reticle of the synthetic image can indicate the estimated position of the target. Additionally or alternatively, an estimated screen coordinate of the target is determined. In some examples, wind and/or wind information is determined and/or estimated. According to some examples disclosed herein, movement of the aircraft is guided based on the estimated position. In some such examples, the aircraft can be guided based on the estimated position (e.g., guided to orbit the estimated position).

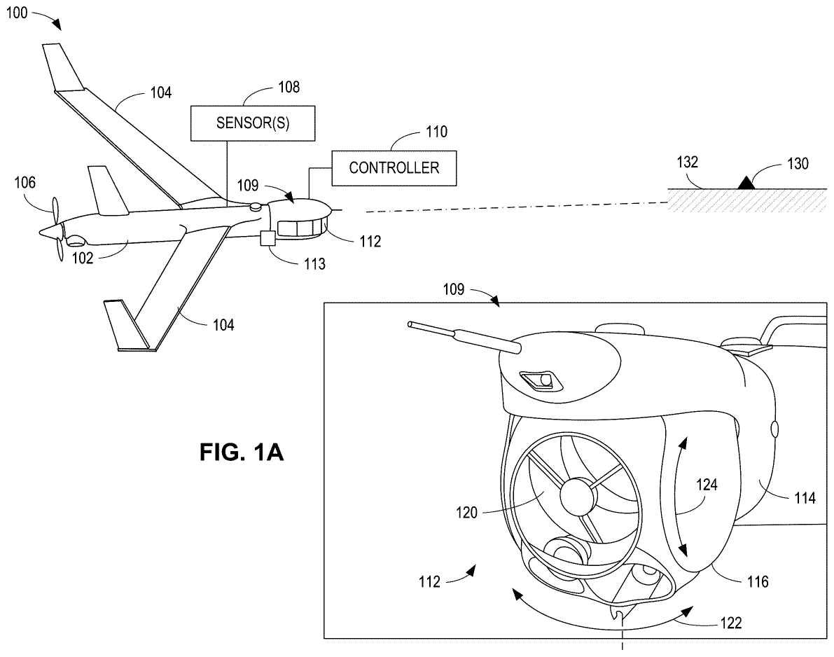

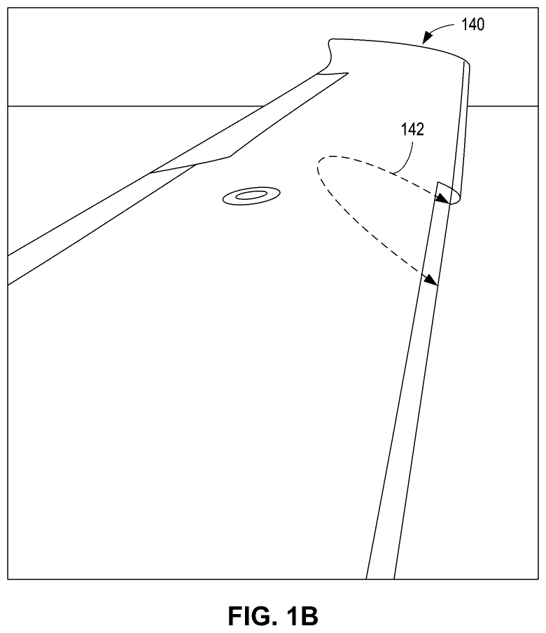

FIG. 1A illustrates an example aircraft 100 in which examples disclosed herein can be implemented. The aircraft 100 of the illustrated example is a fixed wing aircraft, and includes a fuselage 102, wings 104, a propulsion device 106, at least one flight sensor 108, a nose section 109, and a controller (e.g., a flight controller) 110. In turn, the example nose section 109 supports a payload 112, which is implemented as an image sensor (e.g., a camera) in this example and herein referred to as the image sensor 112. The example image sensor 112 can be moved and/or oriented by an aiming device (e.g., a gimbal) 113.

In the illustrated example of FIG. 1A, a detailed view of the example nose section 109 is depicted. In this example, a fuselage portion 114 supports the aiming device 113 having a housing (e.g., a movable housing, a rotatable housing, etc.) 116 which, in turn, positions and/or orients the image sensor 112. Further, the example image sensor 112 includes a sensing portion (e.g., a camera lens, an image sensing portion, etc.) 120. In this example, the housing 116 can be moved, oriented and/or rotated relative to the fuselage portion 114. While an image sensor is implemented in this example, any appropriate other type of sensor can be utilized instead (e.g., an acoustic sensor, a thermal sensor, a magnetic sensor, etc.).

To track a target as the aircraft 100 is in flight, the sensing portion 120 of the image sensor 112 is oriented and/or directed via the aiming device 113. According to examples disclosed herein, the aiming device 113 can be rotated in multiple degrees of freedom, as generally indicated by arrows 122, 124 to track a target (e.g., a ground-based target, a ship-based target, a moving target, a ground-based vehicle target, etc.) 130 or a landing zone (e.g., a landing pad) 132, for example. Accordingly, the aiming device 113 can move the image sensor 112 to track the target while the aircraft 100 is moved in an orbit and/or orbiting motion relative thereto.

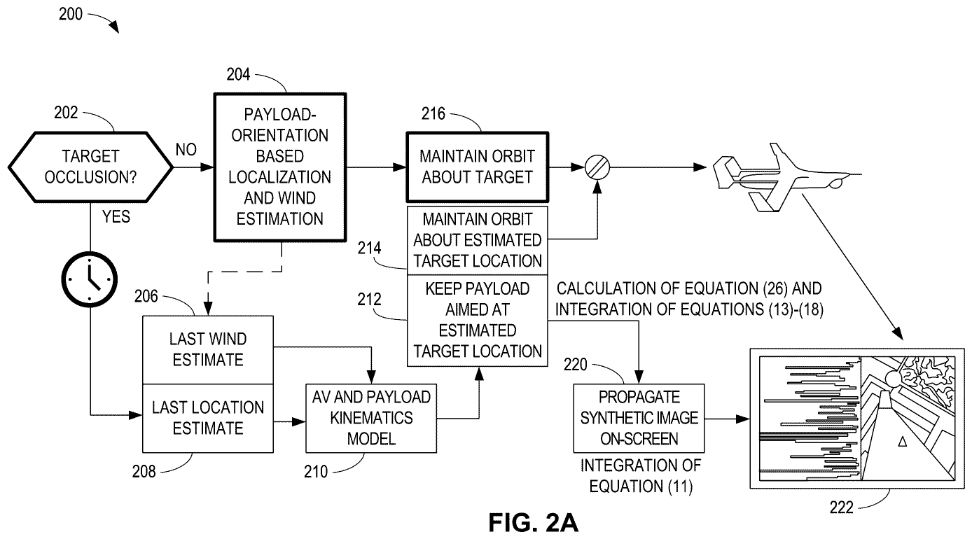

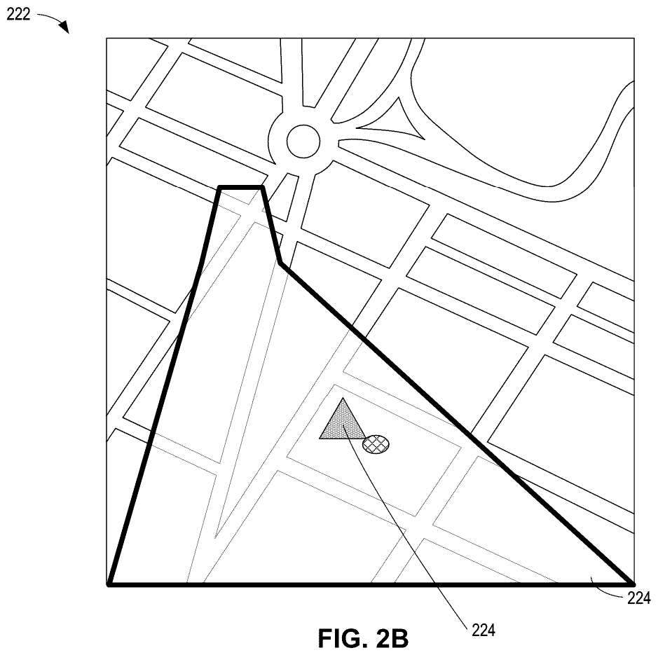

As will be discussed in greater detail below in connection with FIGS. 2-15, examples disclosed herein utilize orientations of the image device 112, the sensing portion 120 and/or the aiming device 113 corresponding to tracking of the target 130 (in conjunction with flight sensor information to estimate a relative position (e.g., a relative screen position or coordinate, etc.) of the target when the target is occluded (e.g., occluded by a portion of the aircraft). According to some examples disclosed herein, wind information, navigation information and/or conditions is/are estimated based on the orientations and the flight sensor information. Accordingly, the wind information and/or conditions can be utilized to guide the movement and/or the navigation of the aircraft 100.

In accordance with teachings of this disclosure, without necessitating GNSS/GPS signals, and utilizing passive sensors, a robust, payload-orientation based AV relative-navigator is enabled. According to some examples disclosed herein, only payload orientation, airdata, and heading is advantageously utilized, thereby enabling robust maneuvering for providing positional estimates of an occluded target, for example. In some examples, a synthetic image and/or representation can be generated and provided to a user to facilitate situational awareness. According to examples disclosed herein, the wind can be taken into account for target position estimation.

FIG. 1B illustrates an occlusion that can occur during tracking. The occlusion may occur temporarily as the aircraft is maneuvering, and can occur cyclically when orbiting in very strong wind conditions, for example. In the illustrated view of FIG. 1B, a point of interest on the ground being occluded by a wing, leading to loss of target-lock is depicted. Losing the target lock is significant when it is also used as the primary navigation source. According to examples disclosed herein, target ‘travel’ relative to the wing can be predicted and expressed in gimbal-angular orientation if an estimate of aircraft location, velocity, and wind is available. Without GPS or other GNSS signals, this is a non-trivial problem.

FIG. 2A illustrates an example process flow 200 of a closed loop targeting architecture in accordance with teachings of this disclosure. In the illustrated example of FIG. 2A, a high-level diagram for a signal flow of a closed loop architecture is depicted.

At block 202, in this example, a presence and/or occurrence of an occlusion is determined. In particular, it is determined whether a target (e.g., a target being tracked) is occluded (partially occluded, fully occluded, etc.). If the target is occluded (block 202), the process proceeds to block 208 (e.g., in a nominal operation). Otherwise, the process proceeds to block 204.

At block 204, according to examples disclosed herein, localization and wind estimates are determined based on payload orientations. In the illustrated example of FIG. 2A, the localization and wind estimates are determined while the target is being tracked and the target is not occluded.

At blocks 206, 208, in this example, when the target is occluded (block 202), a last wind estimate and a last location estimate are utilized. In particular, a prior wind estimate and last known location corresponding to a time prior to the target being occluded are utilized.

At block 210, an AV and payload kinematics model is utilized. In the illustrated example of FIG. 2A, the payload kinematics model utilizes the prior wind estimate and the prior last known location. In turn, an estimated target location (e.g., a screen coordinate estimate) is determined.

At block 212, according to examples disclosed herein, the payload is aimed, oriented and/or directed toward the estimated target location. In particular, a gimbal (or other aiming device) is directed and/or aimed toward the estimated target location even when the target is occluded (e.g., occluded by a portion of the aircraft).

At block 214, the aircraft is controlled to maintain an orbit about the aforementioned estimated target location. According to examples disclosed herein, the aircraft is directed to maneuver and/or orbit relative to the estimated target location (e.g., while the target is occluded).

At block 216, the aircraft is controlled to maintain an orbit about and/or around the target. In this example, the block 216 corresponds to the target not being occluded such that the aircraft can be directed to orbit the target based on a target lock.

At block 220, a synthetic image 222 is displayed on-screen (e.g., a screen of an operator controlling the aircraft). In some examples, an indicator or reticle indicates the estimated position (e.g., screen position, planar position, projected position, etc.) of the target onto the synthetic image 222. In some examples, occluded portions of the scenery are generated/simulated (e.g., via prior images obtained, recently taken images, etc.) and are displayed on the image.

In the illustrated example of FIG. 2A, the blocks 202. 204, 216 correspond to nominal operation (e.g., non-occluded operation), while the blocks 206, 208, 210, 212, 214 and 220 correspond to an alternative mode of operation (e.g., occluded operation) to maintain continuity during a relatively brief occlusion of the target. In other words, examples disclosed herein can operate in different modes based on whether the target is at least partially occluded (e.g., fully occluded)

Turning to FIG. 2B, the example synthetic image 220 mentioned above in connection with FIG. 2A is shown. In the illustrated example of FIG. 2B, a wing 224 is depicted on the display as semi-transparent. Further, an indicator (e.g., a reticle, a pointer, etc.) 226 is shown overlayed onto the synthetic image 220. In this example, the indicator 226 corresponds to an estimated position of the target as the target is occluded by the wing 224. In this example, the indicator 226 moves along with an estimated position of the target. In some examples, the synthetic image also generates and/or displays scenery that is currently occluded (e.g., based on previously stored images).

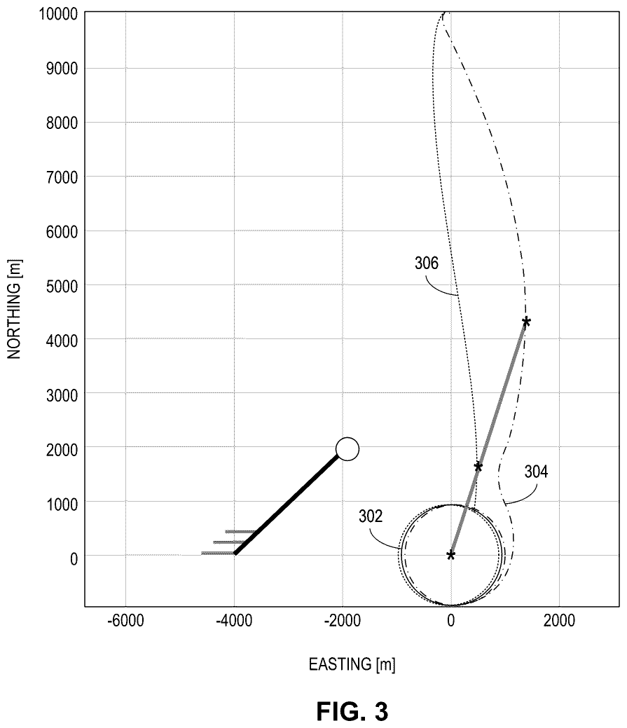

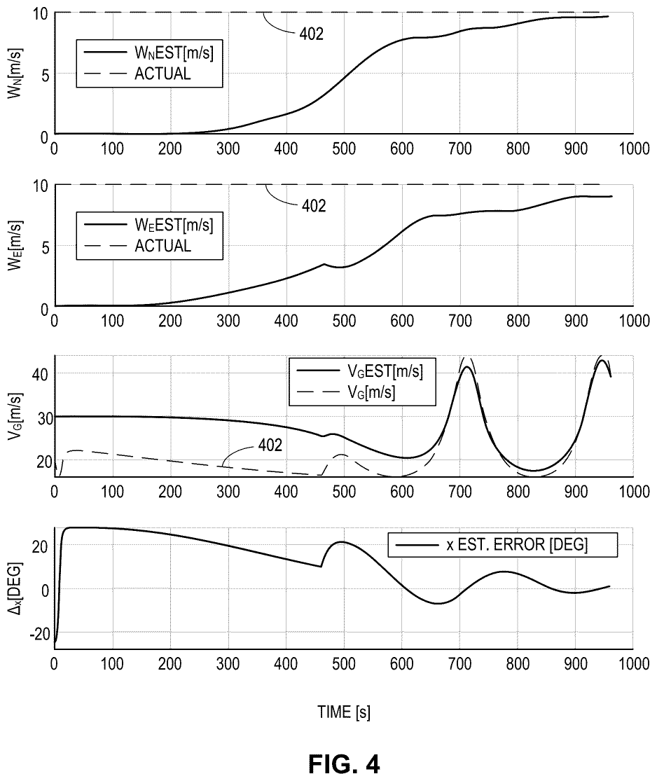

FIGS. 3 and 4 illustrate example results that can be obtained by examples disclosed herein. In particular, a preliminary result of an aircraft or AV flying a mission-task with zero initialization and with 1 hertz (Hz) update (without available GNSS/GPS signals) is shown in FIGS. 3 and 4. This example preliminary result suggests that the approach to, and subsequent orbiting of, a remote target can be supported with a payload orientation alone. As can be seen in the examples of FIGS. 3 and 4, robust results were obtained for a typical ISR mission flight condition.

FIG. 3 illustrates a payload-based estimator (e.g., a payload-based navigation estimator) that is utilized with a closed-loop control, as well as conventional guidance laws. In this particular example, an aircraft is exposed to relatively strong winds from a direction of 225 degrees (deg) at 27.5 knots (Kts), with the aircraft at a true airspeed of 58 Kts. In the illustrated example of FIG. 3, a line 302 corresponds to a commanded orbit, a line 304 corresponds to a true location, and a line 306 corresponds to an indication of estimated position. Accordingly, observability rapidly increases upon approaching orbit.

FIG. 4 illustrates example performance of a payload-based estimator of FIG. 3. In the illustrated example of FIG. 4, lines 402 correspond to truth-values.

FIG. 5 illustrates an example process flow 500 of an example image-based range estimator 500 that can be implemented in examples disclosed herein. In the illustrated example of FIG. 5, a difference between true screen coordinates 502 and expected screen coordinates 504 is determined such that the difference is utilized for an observer gain 506. In turn, camera motion 508 is utilized to determine geometry 510 such that an output error injection is added and/or summed with the observer gain 506 to result in integrated dynamics 512. As a result, a range estimate can be determined. In some examples, the process flow 500 is implemented and/or utilized once the aircraft is brought within sufficient range of the target (e.g., brought to an orbiting range). In other words, examples disclosed herein can be implemented until the aircraft is brought within requisite range and, in turn, another positioning and/or guidance implementation/methodology can be implemented at closer range to the target.

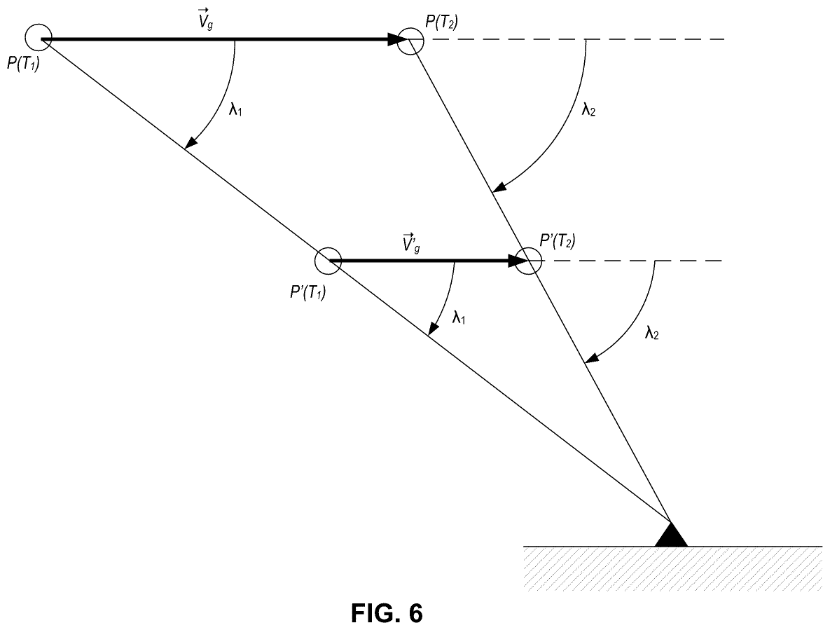

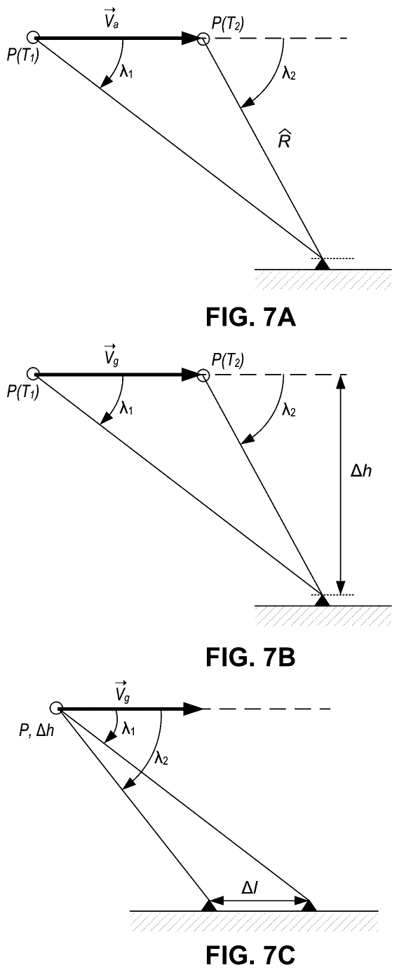

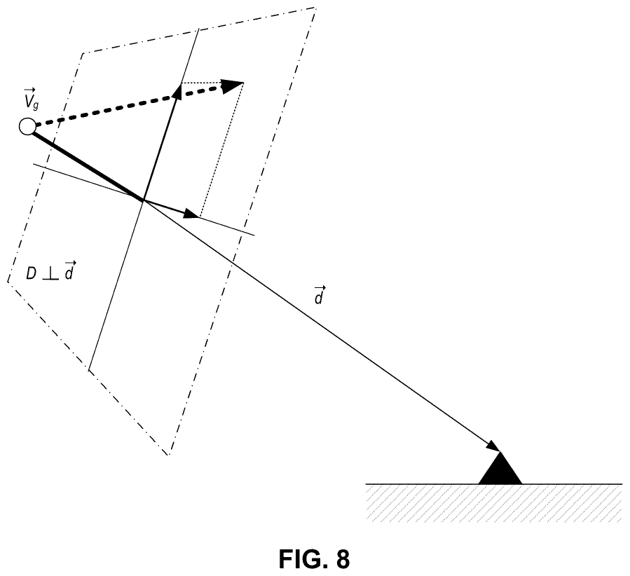

FIG. 6 illustrates an example notional aspect of an estimation problem inherent to bearing-only estimation. Particularly, scale can be an issue for bearing-only estimation methodologies. If traveling in a horizontal plane and only λ₁ and λ₂ are known, then it can be difficult to establish and/or determine ‘fast and far’ from ‘slow and near’ without additional information. Accordingly, an observability problem can result from difficulty in distinguishing between {p(t₁), p(t₂), V_{g}} and {p′(t₁), p′(t₂), V} without a sense of scale. In the mission shown in FIG. 6, there are several options to approach the scaling problem, as indicated in FIGS. 7A-7C discussed below. Further, FIG. 8, which is also discussed below, depicts a more formal observability condition.

FIGS. 7A-7C illustrate example aspects of scaling that can be implemented in examples disclosed herein. In particular, the examples of FIGS. 7A-7C correspond to multiple possibilities to address scaling mentioned above in connection with FIG. 6.

FIG. 7A depicts a principle of Grossman's range estimation corresponding to the payload orientation. In particular, FIG. 7A corresponds to a no-wind assumption of A (\vec{V}ₐ=\vec{V}_{g}) that enables range estimation. Accordingly, it can be assumed that inertial velocity is known and that there is little or no wind and/or wind effects. However, this assumption may not be appropriate for small aircraft/UAV operations and, consequentially, vehicle guidance may rely heavily on robustness and conservative precautions.

FIG. 7B indicates a principle behind approaches of examples disclosed herein. Particularly, FIG. 7B depicts observability using an altimeter such that Δh is known. Accordingly, access to target location and measured barometric pressure can be utilized to determine a distance above the target. In turn, knowledge of the payload angles is utilized to estimate aircraft location and inertial speed. For example, access to aircraft airspeed and can enable full information of wind speed and direction which, in turn, can be subsequently utilized to inform aircraft guidance. Accordingly, an error in the altitude will result in estimation errors in position and wind.

Turning to FIG. 7C, observability utilizing image-based range finding is depicted such that Δl is known. In the illustrated view of FIG. 7C, an example use of Reticle™, which is an image processing toolset that utilizes structure from-motion principles, is shown. FIG. 7B corresponds to observability using image-based range finding such that Δl is known. In the illustrated example, utilization of Reticle™ provides a manner to obtain position estimates that are potentially more accurate than a pure payload orientation-based method. However, the accuracy can come at a cost of computational loading, necessitate access to a terrain database, and may introduce some restrictions on payload motion. In contrast, a pure payload orientation-based method can be implemented on board the AV while the Reticle™ based estimator is run on a GCS.

A formal observability condition for estimation of range and drift from bearing angles alone is depicted in FIG. 8, thereby illustrating that motion in two directions perpendicular to the line-of-sight is required according to known implementations.

FIG. 8 illustrates aspects of a formal observability condition with respect to examples disclosed herein. In particular, FIG. 8 illustrates a formal condition for observability of range and drift is PE, thereby implying continuous maneuvering in the plane perpendicular to the line-of-sight.

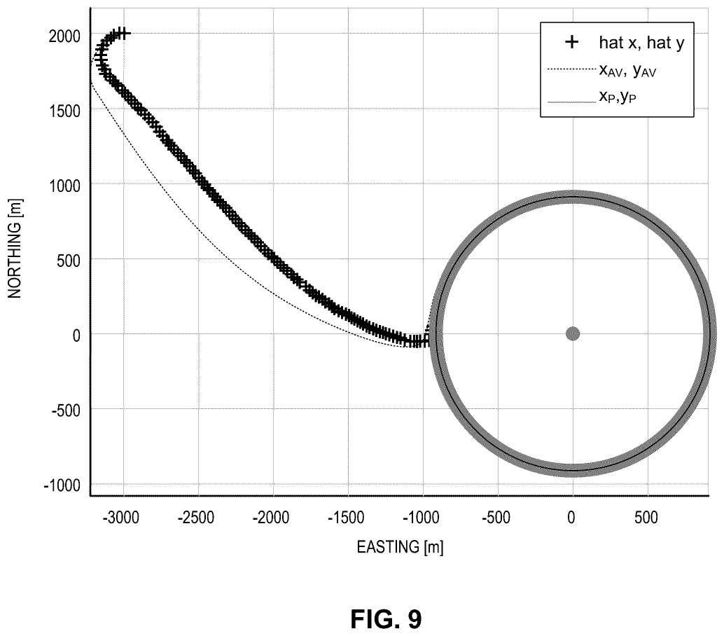

FIG. 9 depicts an example orbit. The orbit shown in FIG. 9 provides excellent target coverage while accommodating relatively good navigation state estimation. This enables utilization of existing guidance logic, despite not having access to GNSS/GPS signals.

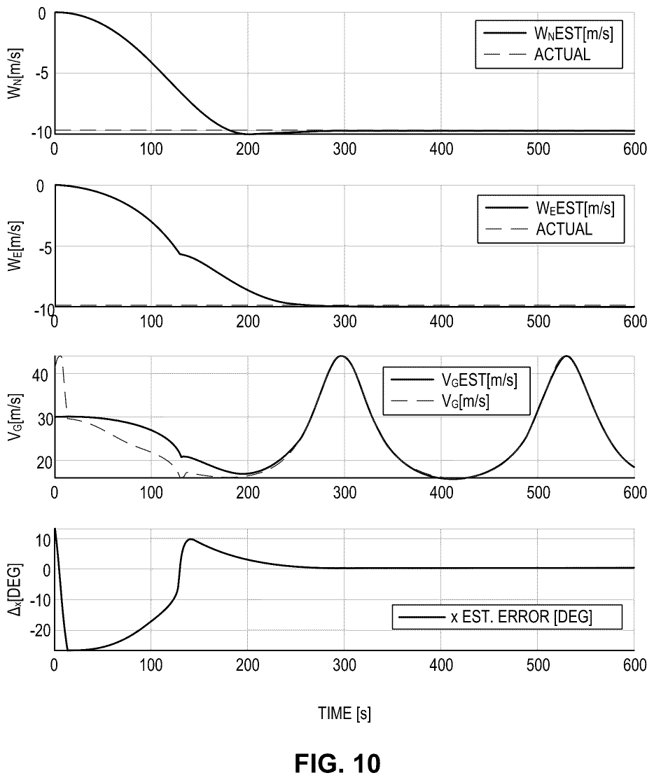

FIG. 10 depicts a rate estimation corresponding to the example orbit shown in FIG. 9.

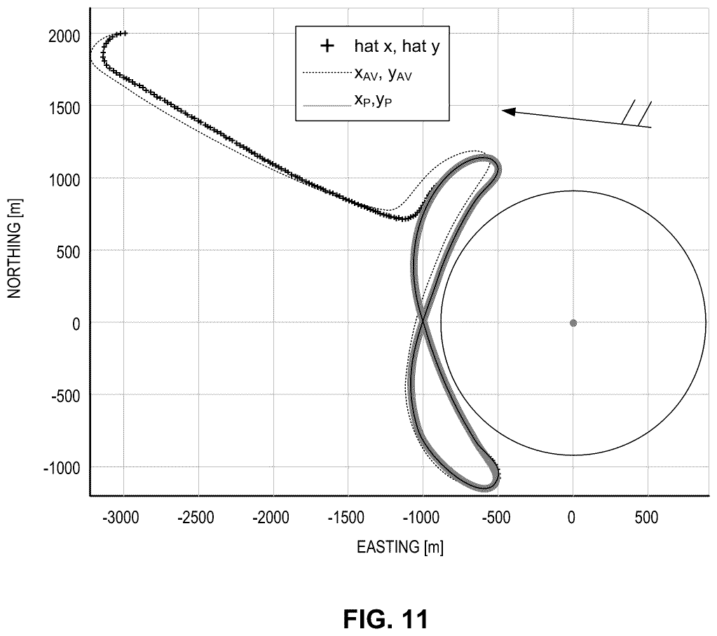

FIG. 11 depicts an example stand-off maneuver. Oriented into the wind, the depicted stand-off maneuver can minimize bank saturation, thereby maximizing target exposure, and consequently improving navigation state estimation.

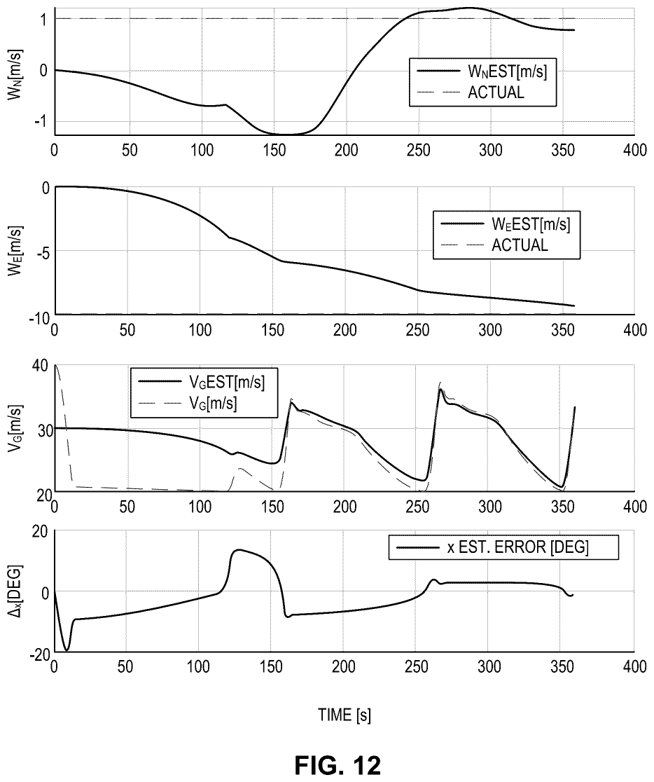

FIG. 12 depicts a rate estimation corresponding to the example orbit shown in FIG. 11.

FIG. 13 illustrates an example result of the consequence of wing occlusion in an orbit in high wind conditions. Information of wind is critical to maintain target-lock and AV orbit control simultaneously. Without the wind estimate, the camera immediately ‘wanders’ and consequently, the target is lost and an aircraft can deviate from its orbit (not shown).

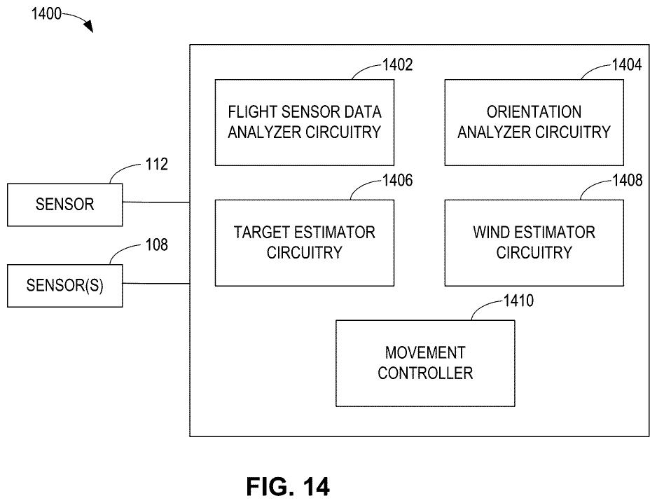

FIG. 14 is a block diagram of an example payload orientation analysis system 1400 to track a target. The payload orientation analysis system 1400 of FIG. 14 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the payload orientation analysis system 1400 of FIG. 14 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 14 may, thus, be instantiated at the same or different times. Some or all of the circuitry of FIG. 14 may be instantiated, for example, in one or more threads executing concurrently on hardware and/or in series on hardware. Moreover, in some examples, some or all of the circuitry of FIG. 14 may be implemented by microprocessor circuitry executing instructions and/or FPGA circuitry performing operations to implement one or more virtual machines and/or containers.

The payload orientation analysis system 1400 of the illustrated example includes example flight sensor data analyzer circuitry 1402, example orientation analyzer circuitry 1404, example target estimator circuitry 1406, example wind estimator circuitry 1408, and example movement controller circuitry 1410. According to examples disclosed herein, the payload orientation analysis system 1400 is communicatively coupled to the flight sensor(s) 108 as well as the image sensor 112.

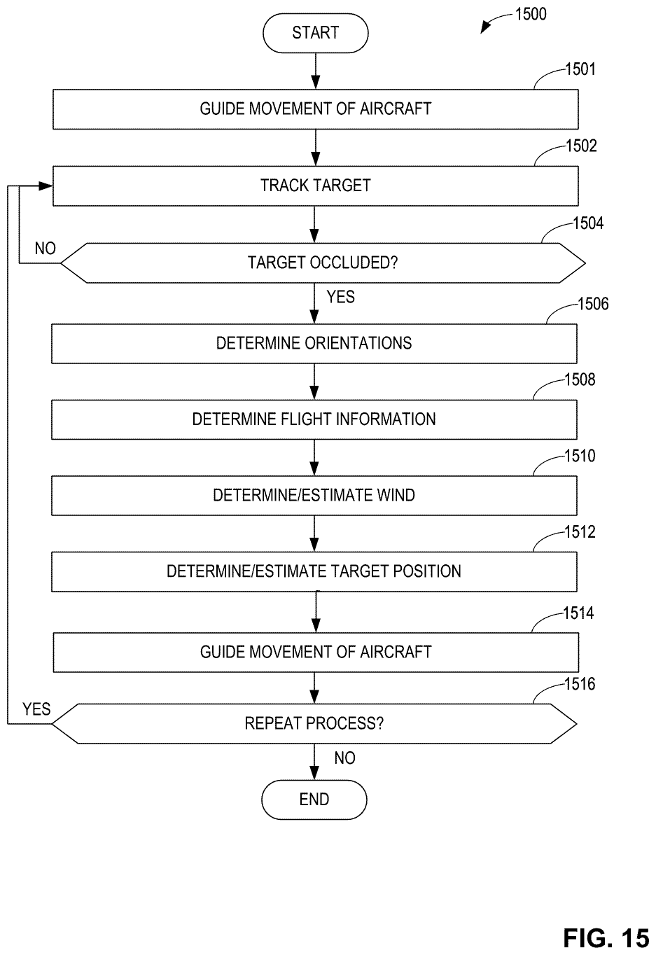

The flight sensor data analyzer circuitry 1402 of the illustrated example is implemented to obtain, access and/or receive sensor data from the flight sensor(s) 108 and/or the image sensor 112. According to examples disclosed herein, the flight sensor data analyzer circuitry 1402 can utilize data (e.g., inertial data, movement data, barometric pressure data, altimeter data, etc.) from the flight sensor(s) 108 as well as image data from the image sensor 112. In turn, the image data can be utilized to track a target, such as a ground-based target, for example. Examples disclosed herein can be utilized for landing the aircraft onto a ground-based target or a moving ship (or other vehicle) and can advantageously enable the aircraft to land by accounting for localized wind/air effects. In some examples, the flight sensor data analyzer circuitry 1402 is instantiated by programmable circuitry executing flight sensor data analyzer instructions and/or configured to perform operations such as those represented by the flowchart of FIG. 15.

According to examples disclosed herein, the orientation analyzer circuitry 1404 is utilized to determine, analyze and/or characterize orientations and/or movement of the image sensor 112 and/or the gimbal as the image sensor 112 is moved to track the aforementioned target. In some examples, the orientation analyzer circuitry 1404 utilizes gimbal data (e.g., inertial gimbal data, gimbal movement data, rotational movement data, angular speed/acceleration data, angular speed, angular acceleration, etc.) corresponding to movement of the image sensor 112 as the image sensor 112 is utilized to track the target via the gimbal. In this example, the orientation analyzer circuitry 1404 characterizes and/or determines the orientation data as the target is being tracked by the image sensor 112. In some examples, the orientation analyzer circuitry 1404 is instantiated by programmable circuitry executing orientation analyzer instructions and/or configured to perform operations such as those represented by the flowchart of FIG. 15.

In this example, the target estimator circuitry 1406 is utilized to determine and/or estimate target position information (e.g., a relative position, a screen position, a screen coordinate, etc.) based on the aforementioned orientations of the image sensor 112 that are measured as the image sensor 112 is moved to track the target along with flight data (e.g., flight instrumentation data, inertial data, barometric data, altimeter data, etc.) corresponding to the flight sensor(s) 108. According to examples disclosed herein, the target estimator circuitry 1406 determines a position and/or orientation of the target relative (e.g., a relative position, a relative orientation, etc.) to the aircraft when the target becomes occluded (e.g., occluded by a portion of the aircraft). Additionally or alternatively, the target estimator circuitry 1406 can estimate navigation information. In some examples, the target estimator circuitry 1406 is instantiated by programmable circuitry executing navigation estimator instructions and/or configured to perform operations such as those represented by the flowchart of FIG. 15.

In some examples, the wind estimator circuitry 1408 is implemented to estimate, calculate and/or determine wind encountered by the aircraft. In some such examples, the wind estimator circuitry 1408 may be implemented to determine wind effects and/or air movement corresponding to the aircraft. In some examples, the wind estimator circuitry 1408 is instantiated by programmable circuitry executing wind estimator instructions and/or configured to perform operations such as those represented by the flowchart of FIG. 15.

In the illustrated example of FIG. 14, the movement controller circuitry 1410 is implemented to control and/or guide movement of the aircraft. According to examples disclosed herein, the movement of the aircraft can be based on the determined target position information. Additionally or alternatively, the movement of the aircraft is controlled based on the determined wind and/or wind effects. In some examples, the movement controller circuitry 1410 controls the aircraft to orbit and/or maneuver relative to the target (e.g., the aircraft is controlled to move along the target in a figure eight path, an orbit and/or a stand-off path, etc.) based on the target position information. In some examples, the movement controller circuitry 1410 is instantiated by programmable circuitry executing movement controller instructions and/or configured to perform operations such as those represented by the flowchart of FIG. 15.

Examples disclosed can implement the following calculations, methodology and/or estimation techniques. However, any other appropriate calculations, methodology and/or estimation techniques can be implemented instead. Example methodology disclosed herein utilizes kinematics. Examples disclosed herein can be applicable to any fixed wing configuration aircraft (or other appropriate type of aircraft) that carries a directed or aimed payload, for example a gimballed camera, a fixed wide-angle camera with known orientation, or a phased array type sensor, etc.

According to examples disclosed herein, an aircraft may be represented in kinematics as follows as example Equations 1-6:

$${\dot{x}}_{N} = {V}_{a} {c}_{ψ} + {w}_{N} \qquad ( 1 )$$

$${\dot{y}}_{E} = {V}_{a} {s}_{ψ} + {w}_{E} \qquad ( 2 )$$

$$\dot{ψ} = {u}_{ψ} \qquad ( 3 )$$

$$\dot{φ} = {u}_{φ} \qquad ( 4 )$$

$$\dot{κ} = {u}_{κ} \qquad ( 5 )$$

$$\dot{λ} = {u}_{λ} , \qquad ( 6 )$$

where {x_{N}, y_{E}} represent position North and East, the orientation is given by heading angle ψ and bank angle φ, and the camera is oriented with pan and tilt angles, respectively, denoted as κ and λ. In this example, Vₐ represents the airspeed that is set based on aircraft characteristics and typically compromises on airspeed tracking are not accepted. According to examples disclosed herein, it can be assumed that appropriate autopilot functions are operational and/or working within acceptable parameters such that Vₐ=Vₐ_{_{c}}. Typically, bank angle dynamics on most conventional fixed wing aircraft follows the commanded bank angle rate at a relatively high bandwidth. Thus, it is reasonable to assume that the tracking of a ground target and the associated orbit of the aircraft occurs at a relatively lower bandwidth as well as a lower bank angle rate that is approximated with a quick first order response to the commanded bank angle, as follows in example Equation 7.

$${u}_{φ} = - φ / {τ}_{φ} + {φ}_{c} / {τ}_{φ} \qquad ( 7 )$$

Most fixed-wing aircraft/AVs are configured to perform coordinated turns, typically relying on inertial sensors, and therefore it is assumed that:

$${u}_{ψ} = \frac{g}{{V}_{a}} tan φ \qquad ( 8 )$$

Accordingly, signals u_{κ} and u_{λ} are driven by image-processing and/or inertial stabilization logic. According to examples disclosed herein, wind in North and East directions, denoted as w_{N} and w_{E} respectively, is unknown and estimated based on other signals and/or additional measurements.

Examples disclosed herein can be utilized for altimetry supported estimation applied to telemetry. Examples disclosed herein utilize an estimator based on the assumption of FIG. 7B. To verify its applicability we will use actual telemetry, including time-stamped payload signals, to reproduce the GPS-based recorded data. The standard telemetry includes (GPS-based) wind-estimates from a commercial autopilot product. Accordingly non-GNSS/GPS navigation and guidance is enabled about a known target location, which can be combined with a vehicle heading estimate to estimate vehicle position.

Examples disclosed herein can implement a state propagation model. To that end, estimated states can include a horizontal position relative to the target, ground speed and its direction, and wind components:

$$x = {( \begin{matrix}Δ {P}_{N} & Δ {P}_{E} & Δ h & {W}_{N} & {W}_{E} & ψ\end{matrix} )}^{T}$$

Airspeed and bank angle can be considered as external inputs. The commanded bank angle is equivalent to a commanded turn-rate through the coordinated turn condition. Accordingly, altitude regulation can be taken into account via the airdata system as an independent signal, which is akin to a ‘flat-earth’ assumption, albeit with the possibility of some barometric variation addressed later. Consider therefore the control signal:

$$u = {( \begin{matrix}{V}_{a} & {ω}_{c} & {γ}_{c}\end{matrix} )}^{T}$$

Note that γ_{c}≈\dot{h}_{c}/Vₐ and that the ISR-mission tasks are performed with \dot{h}_{c}(t)=0.

According to examples disclosed herein, a propagation model \dot{x}=f(x, u) is expressed as:

$$Δ {\dot{P}}_{N} = {W}_{N} + {V}_{a} cos ψ$$

$$Δ {\dot{P}}_{E} = {W}_{E} + {V}_{a} sin ψ$$

$$Δ \dot{h} = {V}_{a} {γ}_{c}$$

$${\dot{W}}_{N} = {\dot{W}}_{E} = 0$$

$$\dot{ψ} = {ω}_{c}$$

Examples disclosed herein can utilize a measurement model. Accordingly, measurements can include payload orientation signals:

$$y = {( \begin{matrix}λ & β & \dot{λ} & \dot{β}\end{matrix} )}^{T} \qquad ( 9 )$$

For notational convenience, according to examples disclosed herein, range and horizontal range can be represented as follows:

$$R \text{?} \sqrt{Δ {P}_{N}^{2} + Δ {P}_{E}^{2} + Δ {h}^{2}} \qquad ( 10 )$$

$${R}_{h} \text{?} \sqrt{Δ {P}_{N}^{2} + Δ {P}_{E}^{2}} \qquad ( 11 )$$

According to examples disclosed herein, the measurement model y=H(x, u) can be expressed as:

$$λ = arctan \{ Δ h / {R}_{h} \} \qquad ( 12 )$$

$$β = ( arctan \{ Δ {P}_{E} / Δ {P}_{N} \} - π ) - ψ \qquad ( 13 )$$

$$\dot{λ} = \frac{{V}_{a} {γ}_{c} {R}_{h}^{2} - Δ h ( Δ {P}_{N} {V}_{N} + Δ {P}_{E} {V}_{E} )}{{R}_{h} {R}^{2}} \qquad ( 14 )$$

$$\dot{β} = \frac{( Δ {P}_{N} {V}_{E} - Δ {P}_{E} {V}_{N} )}{{R}_{h}^{2}} - {ω}_{c} , \qquad ( 15 )$$

$$where$$

$${V}_{N} = {W}_{N} + {V}_{a} cos ψ$$

$${V}_{E} = {W}_{E} + {V}_{a} sin ψ$$

According to examples disclosed herein, some useful variations of measurement model example Equation 9 can be utilized in a Kalman-Filter like formulation. For example, direct heading measurements can be relatively noisy and possibly biased. Accordingly, standard models can be used to augment the measurement model. Similarly, over a relatively long mission, temporal or spatial variations in barometric pressure, which affects altitude estimates, can be accounted for in the measurement model.

Examples disclosed herein can be demonstrated in a stand-off maneuver. When the output from the payload orientation-based estimator is combined with existing guidance logic, orbiting can be achieved seamlessly within conventional control infrastructures, as demonstrated in FIGS. 9-12. This also implies that more complex maneuvers can be commanded, for instance a stand-off maneuver as demonstrated in FIGS. 11 and 12. Similar to the orbiting logic, the observability benefits from proximity and a path perpendicular to the line-of-sight. This implies that the estimator naturally accommodates both the orbit and the stand-off target observation maneuvers, with excellent wind estimation.

As mentioned above, FIG. 2A corresponds to a turret/payload-based guidance with dead-reckoning screen coordinates. In particular, the example of FIG. 2A provides an example of controller architecture in accordance with teachings of this disclosure. The following section provides the corresponding algebra necessary for implementation and evaluation of the example controller architecture.

Examples disclosed herein utilize screen coordinates and an interaction Matrix. In known typical avionics architectures, guidance logic for path following produces a commanded bank angle that drives the aircraft to the path with certain desired characteristics. The commanded bank angle can be produced from the aircraft coordinates relative to its desired path. Typically, GNSS/GPS signals and waypoint geometry are utilized to generate the cross track error, which is to be reduced and/or minimized by steering the aircraft as appropriate.

Examples disclosed herein can reproduce this desired helmsman behavior in the absence of GNSS/GPS signals, while accommodating occasional occlusion of the target. The feasibility can be demonstrated utilizing onboard sensors, turret orientation, and an estimator. The estimator is based on the assumption that a target is in sight of the camera and that the camera is capable of remaining locked onto that target under nominal conditions. This assumption is based on common practice and accomplished using readily available image-processing techniques which track features within the image sequence.

Examples disclosed herein can utilize an interaction matrix. For example, the interaction matrix refers to the effect of camera motion on screen coordinates of stationary objects. This is a well established transformation in image-based visual servoing (IBVS) and is also referred to as an image Jacobian or feature sensitivity matrix.

$$( \begin{matrix}{\dot{s}}_{1} \\ {s}_{2}\end{matrix} ) {}_{s} {L}_{c} ( Z ) {( \begin{matrix}{v}_{c} \\ {}_{i} {ω}_{c}\end{matrix} )}_{c} \qquad ( 16 )$$

With a frame associated with the camera that is oriented with its z-axis along the line-of-sight (los), the interaction matrix can be defined as:

$${}_{s} {L}_{c} ( Z ) = ( \begin{matrix}- 1 / Z & 0 & x / Z & x y & - ( 1 + {x}^{2} ) & y \\ 0 & - 1 / Z & y / Z & ( 1 + {y}^{2} ) & - xy & - x\end{matrix} ) \qquad ( 17 )$$

Examples disclosed herein can relate screen coordinates to vehicle kinematics. To that end, the following rotation matrices can be utilized at every time step. In particular, rotation from body to camera frame can be expressed as follows:

$${}_{c} {R}_{b} = ( \begin{matrix}- {s}_{κ} & {c}_{κ} & 0 \\ {c}_{κ} {s}_{λ} & {s}_{κ} {s}_{λ} & {c}_{λ} \\ {c}_{κ} {c}_{λ} & {s}_{κ} {c}_{λ} & - {s}_{λ}\end{matrix} ) \qquad ( 18 )$$

Rotation from navigation to body frame can be expressed as follows:

$${}_{b} {R}_{n} ( Θ ) \approx {}_{b} {R}_{n} ( φ , ψ ) = ( \begin{matrix}{c}_{ψ} & {s}_{ψ} & 0 \\ - {c}_{φ} {s}_{ψ} & {c}_{φ} {c}_{ψ} & {s}_{φ} \\ {s}_{φ} {s}_{ψ} & - {s}_{φ} {c}_{ψ} & {c}_{φ}\end{matrix} ) \qquad ( 19 )$$

where Θ=(φ, θ, ψ) represents attitude in Euler-angles. During a typical fixed wing flight, pitch may be neglected as it nominally remains relatively small and generally near constant.

A rotation from a navigation frame to a camera can be expressed as follows.

$${}_{c} {R}_{n} = {}_{c} {R}_{b} {}_{b} {R}_{n} \qquad ( 20 )$$

The kinematics model of the AV motion can be represented by the following state vector.

$$x = {( \begin{matrix}{\vec{P}}^{T} & Θ & κ & λ\end{matrix} )}^{T} \qquad ( 21 )$$

or with pitch neglected:

$$x = {( \begin{matrix}{x}_{N} & {y}_{E} & - Δ h & ψ & φ & κ & λ\end{matrix} )}^{T} \qquad ( 22 )$$

The velocity twist of the camera is related to these states as:

$${( \begin{matrix}{V}_{c} \\ {}_{i} {ω}_{c}\end{matrix} )}_{c} = {}_{c} {M}_{x} \dot{x} , \qquad ( 23 )$$

$$where$$

$${}_{c} {M}_{x} = [ \begin{matrix}{}_{c} {R}_{n} & {O}_{3 \times 2} & {O}_{3 \times 2} \\ {O}_{3 \times 3} & {}_{c} {R}_{b} ( \begin{matrix}0 & 1 \\ {s}_{φ} & 0 \\ {c}_{φ} & 0\end{matrix} ) & ( \begin{matrix}0 & 1 \\ {c}_{λ} & 0 \\ - {s}_{λ} & 0\end{matrix} )\end{matrix} ] \qquad ( 24 )$$

The rate of change of the kinematic state can be represented as follows.

$$\dot{x} = {}_{x} {N}_{V} U + {}_{x} {N}_{w} w \qquad ( 25 )$$

$$where$$

$${}_{x} {N}_{V} \text{?} [ \begin{matrix}{c}_{ψ} & \\ {s}_{ψ} & {O}_{3 \times 4} \\ - {γ}_{c} & \\ {O}_{4 \times 1} & {I}_{4 \times 4}\end{matrix} ] , {}_{x} {N}_{w} \text{?} [ \begin{matrix}{I}_{4 \times 4} \\ {O}_{4 \times 3}\end{matrix} ]$$

and U=[Vₐ \dot{ψ} \dot{φ} \dot{κ} \dot{λ}]^{T} is a known set of control signals, and w=[w_{N} w_{E} w_{D}]^{T} is an unknown disturbance that must be estimated. When the above is combined with Equation 16, we obtain the following relation between the kinematics and the screen coordinates.

$$\dot{s} = {}_{s} {L}_{cc} {M}_{x x} {N}_{V} U + {}_{s} {L}_{cc} {M}_{x x} {N}_{w} w \text{?} {M}_{U} U + {M}_{w} w \qquad ( 26 )$$

Dead reckoning can occur by integration:

$$\hat{s} ( t ) = {\int }_{{t}_{0}}^{t} \{ {M}_{U} ( τ ) U ( τ ) + {M}_{w} ( τ ) w ( τ ) \} d τ , \qquad ( 27 )$$

where t₀ represents the moment that the wing is first occluding the features being tracked.

It is noted that, when GPS is available, propagating s(t) using the above is almost trivially achievable with signals derived from common inertial navigation products. However, in the absence of GNSS signals and/or global positioning information, the elements of w must be estimated from the signals in U and this becomes a non-trivial problem.

Significantly, if w can be estimated, then Equation 26 can be utilized to propagate the screen coordinates forward in time (i.e., the coordinates of features on the screen can be dead reckoned by integration of the right hand side of Equation 26. This may be used to provide a momentary virtual scene, effectively providing a transparency to the wing that is occluding the image.

Examples disclosed herein can correspond to propagating camera motion and maintaining orbit during an occlusion. In a typical mission scenario, the camera payload is stabilized when ‘locked-on-target’ (e.g., the payload remains aimed at a point of interest regardless of aircraft motion). This stabilization is based on a combination of inertial camera stabilization and image processing tools like feature tracking, for example. Alternative methods might include automated target recognition, or station keeping via an image database. Thus, this stabilization is generally independent of aircraft state information. The stabilization process can be represented as follows. Performance can be defined through an error-variable based on screen coordinates and camera orientation:

$$e = ( \begin{matrix}{s}_{1} \\ {s}_{2} \\ κ - {κ}_{c}\end{matrix} ) \qquad ( 28 )$$

Driving this error variable to zero will result in the screen coordinates centered at the target, and, with κ_{c}=±π/2+Δ_{w}, the aircraft orienting its inertial velocity perpendicular to the line of sight. This is essentially the function of image stabilization.

The error dynamics can now be combined to derive a control law for heading rate of change and turret angles simultaneously, by an inverse control law. Rewriting Equation 26 in the form of Equation 28 allows the error dynamics to be expressed as follows.

$$\dot{e} = A ( \begin{matrix}{V}_{a} \\ {u}_{ψ} \\ {u}_{φ}\end{matrix} ) + B ( \begin{matrix}{u}_{κ} \\ {u}_{λ}\end{matrix} ) + {B}_{w} ( \begin{matrix}{w}_{N} \\ {w}_{E} \\ {w}_{D}\end{matrix} ) \qquad ( 29 )$$

$$A = ( \begin{matrix}{M}_{U} ( : , 1 : 3 ) \\ {O}_{1 \times 3}\end{matrix} ) , B = ( \begin{matrix}{M}_{U} ( : , 4 : 5 ) \\ \begin{matrix}1 & 0\end{matrix}\end{matrix} ) , {B}_{w} = ( \begin{matrix}{M}_{w} \\ {O}_{1 \times 3}\end{matrix} ) \qquad ( 30 )$$

The aforementioned stabilization can be expressed as dynamic behavior for screen coordinates and camera orientation with feedback:

$$K = ( \begin{matrix}{K}_{s} & O \\ 0 & {k}_{p}\end{matrix} ) \qquad ( 31 )$$

with kₚ>0 and Kₛ positive definite, stabilizing ė=−Ke to e=O.

Given that the camera stabilization generally occurs at a relatively higher bandwidth than the aircraft maneuvering in its orbit, a requisite camera orientation can be propagated using Equation 29 with a pseudo-inverse as follows.

$$( \begin{matrix}{u}_{κ} \\ {u}_{λ}\end{matrix} ) = {( {B}^{T} B )}^{- 1} {B}^{T} \{ - A ( \begin{matrix}{V}_{a} \\ {u}_{ψ} \\ {u}_{φ}\end{matrix} ) - {B}_{w} ( \begin{matrix}{w}_{N} \\ {w}_{E} \\ {w}_{D}\end{matrix} ) \} \qquad ( 32 )$$

The independent signals in Equation 32 are determined by the nature of the kinematics and the desired configuration. If the image cannot remain centered on the target, for example due to camera characteristics, field-of-view restrictions, or motion constraints, then e≠O and off-center screen-coordinates can be accounted for, for example:

$$( \begin{matrix}{u}_{κ} \\ {u}_{λ}\end{matrix} ) = {( {B}^{T} B )}^{- 1} {B}^{T} \{ - K e - A ( \begin{matrix}{V}_{a} \\ {u}_{ψ} \\ {u}_{φ}\end{matrix} ) - {B}_{w} ( \begin{matrix}{w}_{N} \\ {w}_{E} \\ {w}_{D}\end{matrix} ) \} \qquad ( 33 )$$

Accordingly, the airspeed is set based on AV/aircraft characteristics and typically no compromises on airspeed tracking are accepted. Therefore, it can be assumed that appropriate autopilot functions such that Vₐ=Vₐ_{_{c}}.

The bank angle dynamics on most conventional fixed wing aircraft is typically crisp and follows the commanded bank angle rate at high bandwidth. It is reasonable to assume that the tracking of a ground target and associated orbit occurs at a lower bandwidth and therefore it can be assumed that the bank angle rate is well approximated with a quick first order response to the commanded bank angle as follows.

$${u}_{φ} = - {k}_{φ} φ + {k}_{φ} {φ}_{c} \qquad ( 34 )$$

With a large orbit radius and typical wind conditions, it is likely acceptable to assume that φ=φ_{c} and \dot{φ}≈0. With airspeed regulated, the turn rate is a consequence of the bank-angle logic, and hence the following can be assumed:

$${u}_{ψ} = {ω}_{c} = \frac{g}{{V}_{a}} tan ( {φ}_{c} )$$

Defining crab-angle as Δ_{w} [symbol] χ−ψ, then the kinematics of a coordinated turn orbit in wind suggest the following:

$$\dot{χ} = \frac{{V}_{g}}{{R}_{c}} = \frac{g}{{V}_{g}} tan ( φ ) cos ( {Δ}_{w} )$$

This may be used to derive the required nominal bank angle on orbit as:

$${φ}_{c} = arctan \{ \frac{{V}_{g}^{2}}{g {R}_{d}} \frac{1}{cos ( {Δ}_{w} )} \} \qquad ( 35 )$$

In turn, the commanded pan angle κ_{c} is determined from idealized geometry as:

$${κ}_{c} = \pm \frac{π}{2} + {Δ}_{w} \qquad ( 36 )$$

Maneuvering in the presence of wind can introduce additional inputs to the performance variables. The additional inputs can reflect how aircraft orientation and speed are changing in orbit. This is significant because example control laws attempt to both orient the camera relative to the aircraft platform, while also guiding the vehicle relative to an inertially stationary point. To make these signals explicit, some known implementations express the vehicle dynamics derived from coordinated turn kinematics and the ‘wind triangle’ expressions as follows:

$${\dot{x}}_{N} = {V}_{a} {c}_{ψ} + {W}_{N}$$

$${\dot{y}}_{E} = {V}_{a} {s}_{ψ} + {W}_{E}$$

$$\dot{ψ} = \frac{g}{{V}_{a}} {t}_{φ}$$

$${\dot{W}}_{N} = {\dot{W}}_{E} = 0 ,$$

where {W_{N}, W_{E}} represents wind speed North and East. Compared to the no-wind case, the above contains additional information that reflects movement in a uniform flow field where the inertial speed varies with the orientation relative to the flow field, as given by the so-called ‘crab-angle’, Δ_{w}=χ−ψ. According to examples disclosed herein, the inertial course relates to the states can be expressed as follows:

$$χ = {arctan}_{2} \{ {V}_{a} {s}_{ψ} + {W}_{E} , {V}_{a} {c}_{ψ} + {W}_{N} \} \qquad ( 37 )$$

The rotations from navigation to body frame, and from body to camera frame, remain applicable as previously stated, and the velocity twist of the camera remains related to these AV states as presented by Equation 23. Information of wind can be crucial to maintaining target lock and AV orbit control simultaneously. An example result is shown below in connection with FIG. 14. Without the wind estimate, the camera immediately loses target-lock and would also cause the aircraft to deviate from orbit (not shown).

FIG. 11 illustrates a pathway oriented toward the wind, such that a stand-off maneuver minimizes bank saturation and maximizing target. As a result, navigation state estimation is improved.

FIG. 12 illustrates rate estimation performance corresponding to the scenario shown in FIG. 11.

FIG. 13 illustrates an example result of the consequence of wing occlusion in an orbit in high wind conditions. Information of wind can be critical to maintain target-lock and AV orbit control simultaneously. Without the wind estimate, the camera immediately ‘wanders’ and consequently, the target is lost and the aircraft/AV can deviate from its orbit (not shown).

While an example manner of implementing the payload orientation analysis system 1400 is illustrated in FIG. 14, one or more of the elements, processes, and/or devices illustrated in FIG. 14 may be combined, divided, re-arranged, omitted, eliminated, and/or implemented in any other way. Further, the example flight sensor data analyzer circuitry 1402, the example orientation analyzer circuitry 1404, the example target estimator circuitry 1406, the example wind estimator circuitry 1408, the example movement controller circuitry 1410, and/or, more generally, the example payload orientation analysis system 1400 of FIG. 14, may be implemented by hardware alone or by hardware in combination with software and/or firmware. Thus, for example, any of the example flight sensor data analyzer circuitry 1402, the example orientation analyzer circuitry 1404, the example target estimator circuitry 1406, the example wind estimator circuitry 1408, the example movement controller circuitry 1410, and/or, more generally, the example payload orientation analysis system 1400, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example payload orientation analysis system 1400 of FIG. 14 may include one or more elements, processes, and/or devices in addition to, or instead of, those illustrated in FIG. 14, and/or may include more than one of any or all of the illustrated elements, processes and devices.

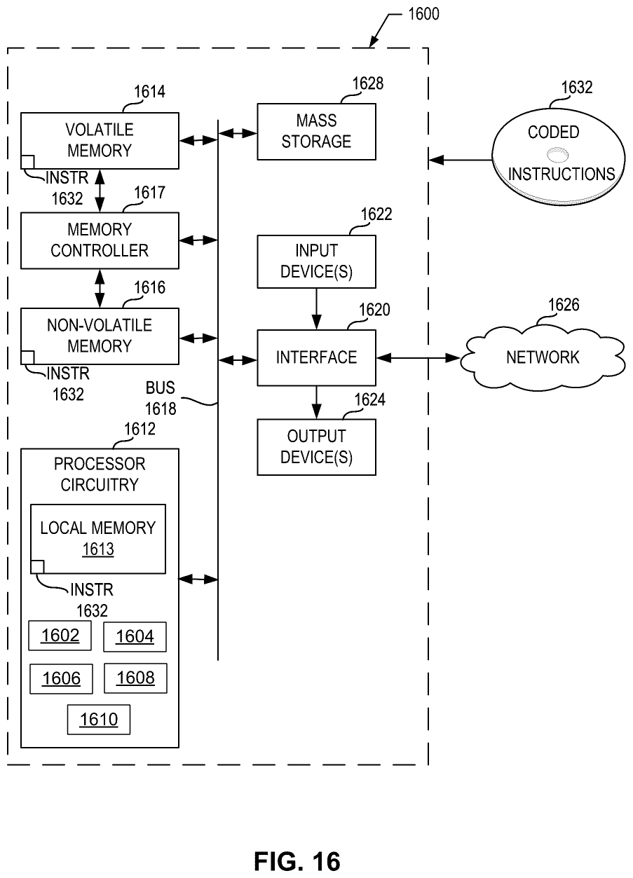

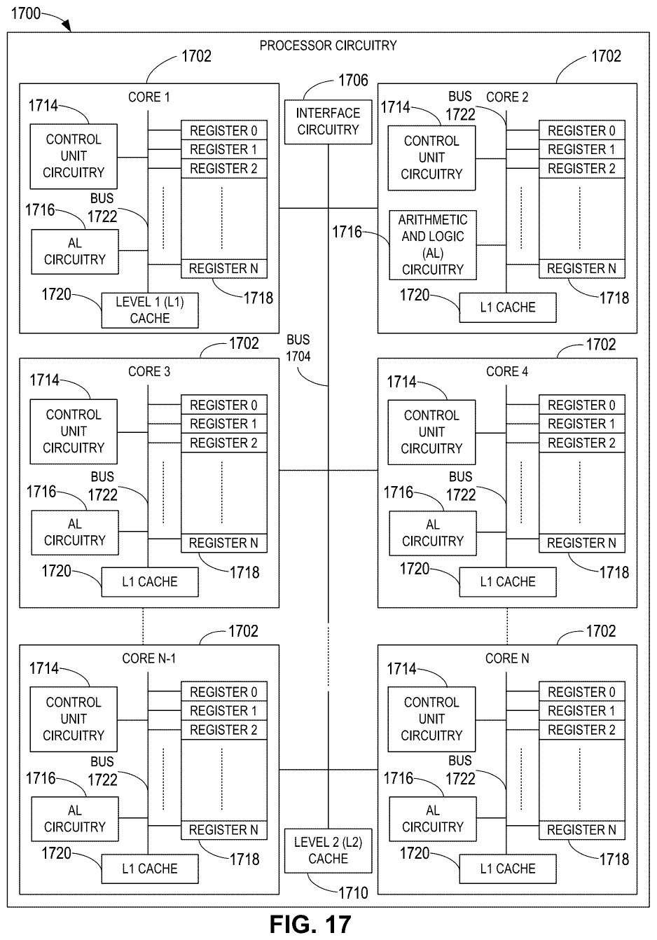

Flowchart(s) representative of example machine readable instructions, which may be executed by programmable circuitry to implement and/or instantiate the payload orientation analysis system 1400 of FIG. 14 and/or representative of example operations which may be performed by programmable circuitry to implement and/or instantiate the payload orientation analysis system 1400 of FIG. 14, are shown in FIG. 15. The machine readable instructions may be one or more executable programs or portion(s) of one or more executable programs for execution by programmable circuitry such as the programmable circuitry 1612 shown in the example processor platform 1600 discussed below in connection with FIG. 16 and/or may be one or more function(s) or portion(s) of functions to be performed by the example programmable circuitry (e.g., an FPGA) discussed below in connection with FIGS. 17 and/or 18. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 15, many other methods of implementing the example payload orientation analysis system 1400 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU and/or an FPGA. The programmable circuitry may include one or more CPUs and/or one or more FPGAs located in the same package (e.g., the same integrated circuit (IC) package or in two or more separate housings), one or more CPUs and/or one or more FPGAs in a single machine, multiple CPUs and/or FPGAs distributed across multiple servers of a server rack, and/or multiple CPUs and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 15 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 15 is a flowchart representative of example machine readable instructions and/or example operations 1500 that may be executed, instantiated, and/or performed by programmable circuitry to track an occluded target via an aircraft (e.g., a fixed wing aircraft). The example machine-readable instructions and/or the example operations 1500 of FIG. 15 begin at block 1501, as the example movement controller circuitry 1410 causes and/or directs the aircraft to be maneuvered relative to the target. According to examples disclosed herein, the movement controller circuitry 1410 directs and/or controls the aircraft to orbit the target and/or an area corresponding to the target. Additionally or alternatively, the example movement controller circuitry 1410 directs the aircraft to move in a pattern, such as a figure-8 or a stand-off pattern movement, with respect to the target and/or the area corresponding to the target.

At block 1502, the movement controller circuitry 1410 of the illustrated example causes a gimbal or any other appropriate movement/aiming device to move and/or orient the image sensor to track the target. In this example, the image sensor is moved based on image data from the image sensor to track the target as the aircraft moves relative to the target. In some examples, the movement controller circuitry 1410 coordinates overall movement of the aircraft along with movement of the gimbal based on the tracking of the target. In some such examples, the overall movement of the aircraft is controlled to maintain the target within a field-of-view (e.g., a center of the field-of-view) of the image sensor.

At block 1504, the example orientation analyzer circuitry 1404 and/or the example target estimator circuitry 1404 determines whether the target is occluded (e.g., partially occluded, fully occluded, etc.). If the target is occluded, the process proceeds to block 1506. Otherwise, the process returns to block 1502.

At block 1506, the example orientation analyzer circuitry 1404 determines orientations of the image sensor and/or the gimbal as the image sensor is oriented by the gimbal while tracking the target (e.g. prior to the target being occluded). According to examples disclosed herein, the example orientation analyzer circuitry 1404 determines orientations of the image sensor and/or the gimbal as the gimbal moves, orients and/or rotates the image sensor to maintain the image sensor oriented (e.g., centered) toward the target as the aircraft is maneuvered relative to the target (orbiting the target, etc.). In some examples, the orientation analyzer circuitry 1404 utilizes gimbal data (e.g., inertial gimbal data, movement data, orientation data, etc.) for determination and/or calculation of the orientations.

At block 1508, the example flight sensor data analyzer circuitry 1402 determines, estimates and/or calculates flight information (e.g., flight data, flight sensor information). According to examples disclosed herein, the flight sensor data analyzer circuitry 1402, receives and/or accesses sensor data corresponding to a flight sensor (e.g., the flight sensor(s) 108). The flight information may include, but is not limited to, barometric data, airspeed, pressure data, inertial flight data, movement data, flight information data, aircraft instrumentation measurements, etc.

At block 1510, in some examples, the wind estimator circuitry 1408 determines, estimates and/or calculates wind information and/or a wind condition. According to some examples disclosed herein, the wind information and/or the wind condition is/are utilized to adjust movement of the aircraft. In other words, movement of the aircraft can be at least partially based on the wind information and/or the wind condition. Additionally or alternatively, navigation information can be estimated.

At block 1512, the example target estimator circuitry 1406 determines, estimates and/or calculates an estimated position information of the target. According to examples disclosed herein, the target estimator circuitry 1406 calculates an estimated screen coordinate of the target based on the orientations and the flight information. Additionally or alternatively, the example target estimator circuitry 1406 utilizes estimated navigation information and/or wind information. In some examples, the target estimator circuitry 1406 calculates and/or determines a relative position and/or orientation of the aircraft relative to the target based on the orientations and the flight information.

At block 1514, the example movement controller circuitry 1410 guides movement of the aircraft based on the estimated position, navigation information, and/or the wind information.

At block 1516, it is determined by the example movement controller circuitry 1410 as to whether to repeat the process. If the process is to be repeated (block 1516), control of the process returns to block 1502. Otherwise, the process ends. The determination may be based on whether the target is occluded or no longer occluded.

FIG. 16 is a block diagram of an example programmable circuitry platform 1600 structured to execute and/or instantiate the example machine-readable instructions and/or the example operations of FIG. 15 to implement the payload orientation analysis system 1400 of FIG. 14. The programmable circuitry platform 1600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1600 of the illustrated example includes programmable circuitry 1612. The programmable circuitry 1612 of the illustrated example is hardware. For example, the programmable circuitry 1612 can be implemented by one or more integrated circuits, logic circuits, FPGAs, microprocessors, CPUs, GPUs, DSPs, and/or microcontrollers from any desired family or manufacturer. The programmable circuitry 1612 may be implemented by one or more semiconductor based (e.g., silicon based) devices. In this example, the programmable circuitry 1612 implements the example flight sensor data analyzer circuitry 1402, the example orientation analyzer circuitry 1404, the example target estimator circuitry 1406, the example wind estimator circuitry 1408, and the example movement controller circuitry 1410.

The programmable circuitry 1612 of the illustrated example includes a local memory 1613 (e.g., a cache, registers, etc.). The programmable circuitry 1612 of the illustrated example is in communication with main memory 1614, 1616, which includes a volatile memory 1614 and a non-volatile memory 1616, by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617. In some examples, the memory controller 1617 may be implemented by one or more integrated circuits, logic circuits, microcontrollers from any desired family or manufacturer, or any other type of circuitry to manage the flow of data going to and from the main memory 1614, 1616.

The programmable circuitry platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1622 are connected to the interface circuitry 1620. The input device(s) 1622 permit(s) a user (e.g., a human user, a machine user, etc.) to enter data and/or commands into the programmable circuitry 1612. The input device(s) 1622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1624 are also connected to the interface circuitry 1620 of the illustrated example. The output device(s) 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1600 of the illustrated example also includes one or more mass storage discs or devices 1628 to store firmware, software, and/or data. Examples of such mass storage discs or devices 1628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1632, which may be implemented by the machine readable instructions of FIG. 15, may be stored in the mass storage device 1628, in the volatile memory 1614, in the non-volatile memory 1616, and/or on at least one non-transitory computer readable storage medium such as a CD or DVD which may be removable.

FIG. 17 is a block diagram of an example implementation of the programmable circuitry 1612 of FIG. 16. In this example, the programmable circuitry 1612 of FIG. 16 is implemented by a microprocessor 1700. For example, the microprocessor 1700 may be a general-purpose microprocessor (e.g., general-purpose microprocessor circuitry). The microprocessor 1700 executes some or all of the machine-readable instructions of the flowchart of FIG. 15 to effectively instantiate the circuitry of FIG. 14 as logic circuits to perform operations corresponding to those machine readable instructions. In some such examples, the circuitry of FIG. 14 is instantiated by the hardware circuits of the microprocessor 1700 in combination with the machine-readable instructions. For example, the microprocessor 1700 may be implemented by multi-core hardware circuitry such as a CPU, a DSP, a GPU, an XPU, etc. Although it may include any number of example cores 1702 (e.g., 1 core), the microprocessor 1700 of this example is a multi-core semiconductor device including N cores. The cores 1702 of the microprocessor 1700 may operate independently or may cooperate to execute machine readable instructions. For example, machine code corresponding to a firmware program, an embedded software program, or a software program may be executed by one of the cores 1702 or may be executed by multiple ones of the cores 1702 at the same or different times. In some examples, the machine code corresponding to the firmware program, the embedded software program, or the software program is split into threads and executed in parallel by two or more of the cores 1702. The software program may correspond to a portion or all of the machine readable instructions and/or operations represented by the flowchart of FIG. 15.

The cores 1702 may communicate by a first example bus 1704. In some examples, the first bus 1704 may be implemented by a communication bus to effectuate communication associated with one(s) of the cores 1702. For example, the first bus 1704 may be implemented by at least one of an Inter-Integrated Circuit (I2C) bus, a Serial Peripheral Interface (SPI) bus, a PCI bus, or a PCIe bus. Additionally or alternatively, the first bus 1704 may be implemented by any other type of computing or electrical bus. The cores 1702 may obtain data, instructions, and/or signals from one or more external devices by example interface circuitry 1706. The cores 1702 may output data, instructions, and/or signals to the one or more external devices by the interface circuitry 1706. Although the cores 1702 of this example include example local memory 1720 (e.g., Level 1 (L1) cache that may be split into an L1 data cache and an L1 instruction cache), the microprocessor 1700 also includes example shared memory 1710 that may be shared by the cores (e.g., Level 2 (L2 cache)) for high-speed access to data and/or instructions. Data and/or instructions may be transferred (e.g., shared) by writing to and/or reading from the shared memory 1710. The local memory 1720 of each of the cores 1702 and the shared memory 1710 may be part of a hierarchy of storage devices including multiple levels of cache memory and the main memory (e.g., the main memory 1614, 1616 of FIG. 16). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1702 may be referred to as a CPU, DSP, GPU, etc., or any other type of hardware circuitry. Each core 1702 includes control unit circuitry 1714, arithmetic and logic (AL) circuitry (sometimes referred to as an ALU) 1716, a plurality of registers 1718, the local memory 1720, and a second example bus 1722. Other structures may be present. For example, each core 1702 may include vector unit circuitry, single instruction multiple data (SIMD) unit circuitry, load/store unit (LSU) circuitry, branch/jump unit circuitry, floating-point unit (FPU) circuitry, etc. The control unit circuitry 1714 includes semiconductor-based circuits structured to control (e.g., coordinate) data movement within the corresponding core 1702. The AL circuitry 1716 includes semiconductor-based circuits structured to perform one or more mathematic and/or logic operations on the data within the corresponding core 1702. The AL circuitry 1716 of some examples performs integer based operations. In other examples, the AL circuitry 1716 also performs floating-point operations. In yet other examples, the AL circuitry 1716 may include first AL circuitry that performs integer-based operations and second AL circuitry that performs floating-point operations. In some examples, the AL circuitry 1716 may be referred to as an Arithmetic Logic Unit (ALU).

The registers 1718 are semiconductor-based structures to store data and/or instructions such as results of one or more of the operations performed by the AL circuitry 1716 of the corresponding core 1702. For example, the registers 1718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1718 may be arranged in a bank as shown in FIG. 17. Alternatively, the registers 1718 may be organized in any other arrangement, format, or structure, such as by being distributed throughout the core 1702 to shorten access time. The second bus 1722 may be implemented by at least one of an I2C bus, a SPI bus, a PCI bus, or a PCIe bus.

Each core 1702 and/or, more generally, the microprocessor 1700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1700 is a semiconductor device fabricated to include many transistors interconnected to implement the structures described above in one or more integrated circuits (ICs) contained in one or more packages.

The microprocessor 1700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1700, in the same chip package as the microprocessor 1700 and/or in one or more separate packages from the microprocessor 1700.

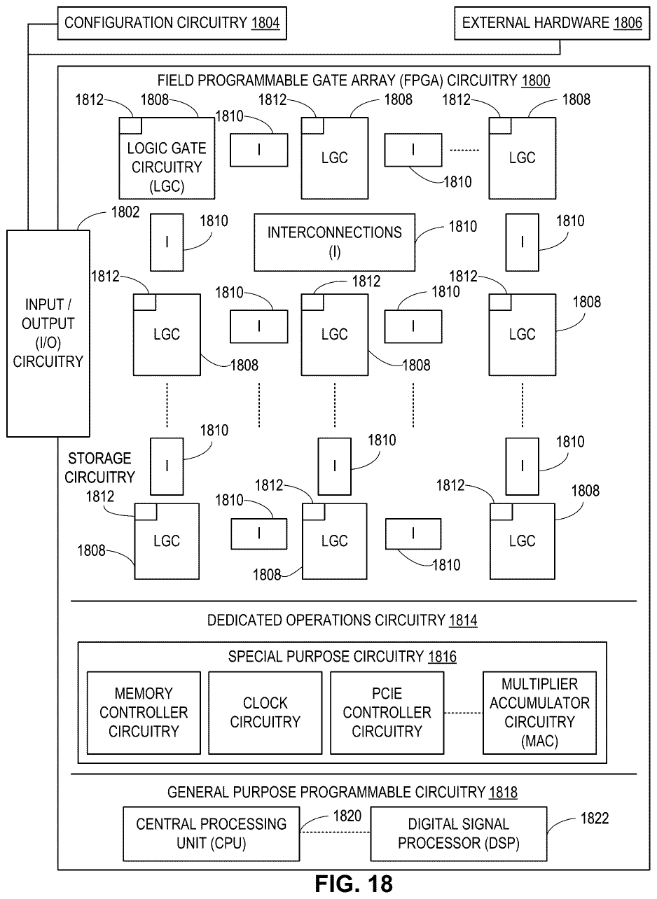

FIG. 18 is a block diagram of another example implementation of the programmable circuitry 1612 of FIG. 16. In this example, the programmable circuitry 1612 is implemented by FPGA circuitry 1800. For example, the FPGA circuitry 1800 may be implemented by an FPGA. The FPGA circuitry 1800 can be used, for example, to perform operations that could otherwise be performed by the example microprocessor 1700 of FIG. 17 executing corresponding machine readable instructions. However, once configured, the FPGA circuitry 1800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1700 of FIG. 17 described above (which is a general purpose device that may be programmed to execute some or all of the machine readable instructions represented by the flowchart of FIG. 15 but whose interconnections and logic circuitry are fixed once fabricated), the FPGA circuitry 1800 of the example of FIG. 18 includes interconnections and logic circuitry that may be configured, structured, programmed, and/or interconnected in different ways after fabrication to instantiate, for example, some or all of the operations/functions corresponding to the machine readable instructions represented by the flowchart of FIG. 15. In particular, the FPGA circuitry 1800 may be thought of as an array of logic gates, interconnections, and switches. The switches can be programmed to change how the logic gates are interconnected by the interconnections, effectively forming one or more dedicated logic circuits (unless and until the FPGA circuitry 1800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 15. As such, the FPGA circuitry 1800 may be configured and/or structured to effectively instantiate some or all of the operations/functions corresponding to the machine readable instructions of the flowchart(s) of FIG. 15 as dedicated logic circuits to perform the operations/functions corresponding to those software instructions in a dedicated manner analogous to an ASIC. Therefore, the FPGA circuitry 1800 may perform the operations/functions corresponding to the some or all of the machine readable instructions of FIG. 15 faster than the general-purpose microprocessor can execute the same.

In the example of FIG. 18, the FPGA circuitry 1800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

The FPGA circuitry 1800 of FIG. 18, includes example input/output (I/O) circuitry 1802 to obtain and/or output data to/from example configuration circuitry 1804 and/or external hardware 1806. For example, the configuration circuitry 1804 may be implemented by interface circuitry that may obtain a binary file, which may be implemented by a bit stream, data, and/or machine-readable instructions, to configure the FPGA circuitry 1800, or portion(s) thereof. In some such examples, the configuration circuitry 1804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1806 may be implemented by external hardware circuitry. For example, the external hardware 1806 may be implemented by the microprocessor 1700 of FIG. 17.

The FPGA circuitry 1800 also includes an array of example logic gate circuitry 1808, a plurality of example configurable interconnections 1810, and example storage circuitry 1812. The logic gate circuitry 1808 and the configurable interconnections 1810 are configurable to instantiate one or more operations/functions that may correspond to at least some of the machine readable instructions of FIG. 15 and/or other desired operations. The logic gate circuitry 1808 shown in FIG. 18 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1808 to enable configuration of the electrical structures and/or the logic gates to form circuits to perform desired operations/functions. The logic gate circuitry 1808 may include other electrical structures such as look-up tables (LUTs), registers (e.g., flip-flops or latches), multiplexers, etc.

The configurable interconnections 1810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1808 to program desired logic circuits.

The storage circuitry 1812 of the illustrated example is structured to store result(s) of the one or more of the operations performed by corresponding logic gates. The storage circuitry 1812 may be implemented by registers or the like. In the illustrated example, the storage circuitry 1812 is distributed amongst the logic gate circuitry 1808 to facilitate access and increase execution speed.

The example FPGA circuitry 1800 of FIG. 18 also includes example dedicated operations circuitry 1814. In this example, the dedicated operations circuitry 1814 includes special purpose circuitry 1816 that may be invoked to implement commonly used functions to avoid the need to program those functions in the field. Examples of such special purpose circuitry 1816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1800 may also include example general purpose programmable circuitry 1818 such as an example CPU 1820 and/or an example DSP 1822. Other general purpose programmable circuitry 1818 may additionally or alternatively be present such as a GPU, an XPU, etc., that can be programmed to perform other operations.

Although FIGS. 17 and 18 illustrate two example implementations of the programmable circuitry 1612 of FIG. 16, many other approaches are contemplated. For example, FPGA circuitry may include an on-board CPU, such as one or more of the example CPU 1820 of FIG. 17. Therefore, the programmable circuitry 1612 of FIG. 16 may additionally be implemented by combining at least the example microprocessor 1700 of FIG. 17 and the example FPGA circuitry 1800 of FIG. 18. In some such hybrid examples, one or more cores 1702 of FIG. 17 may execute a first portion of the machine readable instructions represented by the flowchart of FIG. 15 to perform first operation(s)/function(s), the FPGA circuitry 1800 of FIG. 18 may be configured and/or structured to perform second operation(s)/function(s) corresponding to a second portion of the machine readable instructions represented by the flowchart of FIG. 15, and/or an ASIC may be configured and/or structured to perform third operation(s)/function(s) corresponding to a third portion of the machine readable instructions represented by the flowchart of FIG. 15.

It should be understood that some or all of the circuitry of FIG. 14 may, thus, be instantiated at the same or different times. For example, same and/or different portion(s) of the microprocessor 1700 of FIG. 17 may be programmed to execute portion(s) of machine-readable instructions at the same and/or different times. In some examples, same and/or different portion(s) of the FPGA circuitry 1800 of FIG. 18 may be configured and/or structured to perform operations/functions corresponding to portion(s) of machine-readable instructions at the same and/or different times.

In some examples, some or all of the circuitry of FIG. 14 may be instantiated, for example, in one or more threads executing concurrently and/or in series. For example, the microprocessor 1700 of FIG. 17 may execute machine readable instructions in one or more threads executing concurrently and/or in series. In some examples, the FPGA circuitry 1800 of FIG. 18 may be configured and/or structured to carry out operations/functions concurrently and/or in series. Moreover, in some examples, some or all of the circuitry of FIG. 14 may be implemented within one or more virtual machines and/or containers executing on the microprocessor 1700 of FIG. 17.

In some examples, the programmable circuitry 1612 of FIG. 16 may be in one or more packages. For example, the microprocessor 1700 of FIG. 17 and/or the FPGA circuitry 1800 of FIG. 18 may be in one or more packages. In some examples, an XPU may be implemented by the programmable circuitry 1612 of FIG. 16, which may be in one or more packages. For example, the XPU may include a CPU (e.g., the microprocessor 1700 of FIG. 17, the CPU 1820 of FIG. 18, etc.) in one package, a DSP (e.g., the DSP 1822 of FIG. 18) in another package, a GPU in yet another package, and an FPGA (e.g., the FPGA circuitry 1800 of FIG. 18) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable effective tracking of a target even when the target is occluded are disclosed herein. Further examples and combinations thereof include the following:

Example 1 includes an apparatus comprising interface circuitry communicatively coupled to an aiming device and an image sensor carried by an aircraft, machine-readable instructions, and at least one processor circuit to be programmed by the machine-readable instructions to determine that a target has been occluded as the image sensor is directed toward the target via the aiming device to track the target, determine, in response to the target being occluded, orientations of the image sensor during tracking of the target, and determine an estimated position of the target based on flight sensor information of the aircraft and the orientations for directing the aiming device during the occlusion of the target.

Example 2 includes the apparatus as defined in example 1, wherein one or more of the at least one processor circuit is to guide movement of the aiming device based on the estimated position.

Example 3 includes the apparatus as defined in example 1, wherein one or more of the at least one processor circuit is to estimate wind information, and wherein the estimated position is determined based on the estimated wind information.

Example 4 includes the apparatus as defined in example 1, wherein one or more of the at least one processor circuit is to determine an estimated screen coordinate of the target.

Example 5 includes the apparatus as defined in example 1, wherein one or more of the at least one processor circuit is to generate a synthetic image of scenery occluded.

Example 6 includes the apparatus as defined in example 1, wherein one or more of the at least one processor circuit is to guide movement of the aircraft based on the estimated position.

Example 7 includes the apparatus as defined in example 6, wherein one or more of the at least one processor circuit is to cause the aircraft to maintain an orbit around the target based on the estimated position.

Example 8 includes at least one non-transitory machine-readable medium comprising machine-readable instructions to cause at least one processor circuit to at least determine that a target has been occluded as an image sensor of an aircraft is directed toward the target via an aiming device to track the target, determine, in response to the target being occluded, orientations of the image sensor during tracking of the target, and determine an estimated position of the target based on flight sensor information of the aircraft and the orientations for directing the aiming device during the occlusion of the target.

Example 9 includes the at least one non-transitory machine-readable medium as defined in example 8, wherein the machine-readable instructions are to cause one or more of the at least one processor circuit to guide movement of the aiming device based on the estimated position.

Example 10 includes the at least one non-transitory machine-readable medium as defined in example 8, wherein the machine-readable instructions are to cause one or more of the at least one processor circuit to estimate wind information, and wherein the estimated position is determined based on the estimated wind information.

Example 11 includes the at least one non-transitory machine-readable medium as defined in example 8, wherein the machine-readable instructions are to cause one or more of the at least one processor circuit to determine an estimated screen coordinate of the target.

Example 12 includes the at least one non-transitory machine-readable medium as defined in example 8, wherein the machine-readable instructions are to cause one or more of the at least one processor circuit to generate a synthetic image of scenery occluded.

Example 13 includes the at least one non-transitory machine-readable medium as defined in example 8, wherein the machine-readable instructions are to cause one or more of the at least one processor circuit to guide movement of the aircraft based on the estimated position.

Example 14 includes the at least one non-transitory machine-readable medium as defined in example 13, wherein the machine-readable instructions are to cause one or more of the at least one processor circuit to cause the aircraft to maintain an orbit around the target based on the estimated position.

Example 15 includes a method comprising determining, by at least one processor circuit programmed by at least one instruction that a target has been occluded as an image sensor of an aircraft is directed toward the target via an aiming device to track the target, in response to the target being occluded, determining, by one or more of the at least one processor circuit, orientations of the image sensor during tracking of the target, and determining, by one or more of the at least one processor circuit, an estimated position of the target based on flight sensor information of the aircraft and the orientations for directing the aiming device during the occlusion of the target.

Example 16 includes the method as defined in example 15, including guiding, by one or more of the at least one processor circuit, movement of the aiming device based on the estimated position.

Example 17 includes the method as defined in example 15, including estimating, by one or more of the at least one processor circuit, wind information, and wherein the estimated position is determined based on the estimated wind information.

Example 18 includes the method as defined in example 15, including determining, by one or more of the at least one processor circuit, an estimated screen coordinate of the target.

Example 19 includes the method as defined in example 15, including generating, by one or more of the at least one processor circuit, a synthetic image of scenery occluded.

Example 20 includes the method as defined in example 15, including guiding, by one or more of the at least one processor circuit, movement of the aircraft based on the estimated position.

From the foregoing, it will be appreciated that example systems, apparatus, articles of manufacture, and methods have been disclosed that enable effective guided tracking of a target when the target is occluded. Accordingly, examples disclosed herein can enable effective tracking even in the absence of a GNSS signal, such as a GPS signal.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry communicatively coupled to an aiming device and an image sensor carried by an aircraft;
machine-readable instructions; and
at least one processor circuit to be programmed by the machine-readable instructions to:
determine that a target has been occluded as the image sensor is directed toward the target via the aiming device to track the target;
determine, in response to the target being occluded, orientations of the image sensor during tracking of the target; and
determine an estimated position of the target based on flight sensor information of the aircraft and the orientations for directing the aiming device during the occlusion of the target.

2. The apparatus as defined in claim 1, wherein one or more of the at least one processor circuit is to guide movement of the aiming device based on the estimated position.

3. The apparatus as defined in claim 1, wherein one or more of the at least one processor circuit is to estimate wind information, and wherein the estimated position is determined based on the estimated wind information.

4. The apparatus as defined in claim 1, wherein one or more of the at least one processor circuit is to determine an estimated screen coordinate of the target.

5. The apparatus as defined in claim 1, wherein one or more of the at least one processor circuit is to generate a synthetic image of scenery occluded.

6. The apparatus as defined in claim 1, wherein one or more of the at least one processor circuit is to guide movement of the aircraft based on the estimated position.

7. The apparatus as defined in claim 6, wherein one or more of the at least one processor circuit is to cause the aircraft to maintain an orbit around the target based on the estimated position.

8. At least one non-transitory machine-readable medium comprising machine-readable instructions to cause at least one processor circuit to at least:
determine that a target has been occluded as an image sensor of an aircraft is directed toward the target via an aiming device to track the target;
determine, in response to the target being occluded, orientations of the image sensor during tracking of the target; and
determine an estimated position of the target based on flight sensor information of the aircraft and the orientations for directing the aiming device during the occlusion of the target.

9. The at least one non-transitory machine-readable medium as defined in claim 8, wherein the machine-readable instructions are to cause one or more of the at least one processor circuit to guide movement of the aiming device based on the estimated position.

10. The at least one non-transitory machine-readable medium as defined in claim 8, wherein the machine-readable instructions are to cause one or more of the at least one processor circuit to estimate wind information, and wherein the estimated position is determined based on the estimated wind information.

11. The at least one non-transitory machine-readable medium as defined in claim 8, wherein the machine-readable instructions are to cause one or more of the at least one processor circuit to determine an estimated screen coordinate of the target.

12. The at least one non-transitory machine-readable medium as defined in claim 8, wherein the machine-readable instructions are to cause one or more of the at least one processor circuit to generate a synthetic image of scenery occluded.

13. The at least one non-transitory machine-readable medium as defined in claim 8, wherein the machine-readable instructions are to cause one or more of the at least one processor circuit to guide movement of the aircraft based on the estimated position.

14. The at least one non-transitory machine-readable medium as defined in claim 13, wherein the machine-readable instructions are to cause one or more of the at least one processor circuit to cause the aircraft to maintain an orbit around the target based on the estimated position.

15. A method comprising:
determining, by at least one processor circuit programmed by at least one instruction that a target has been occluded as an image sensor of an aircraft is directed toward the target via an aiming device to track the target;
in response to the target being occluded, determining, by one or more of the at least one processor circuit, orientations of the image sensor during tracking of the target; and
determining, by one or more of the at least one processor circuit, an estimated position of the target based on flight sensor information of the aircraft and the orientations for directing the aiming device during the occlusion of the target.

16. The method as defined in claim 15, including guiding, by one or more of the at least one processor circuit, movement of the aiming device based on the estimated position.

17. The method as defined in claim 15, including estimating, by one or more of the at least one processor circuit, wind information, and wherein the estimated position is determined based on the estimated wind information.

18. The method as defined in claim 15, including determining, by one or more of the at least one processor circuit, an estimated screen coordinate of the target.

19. The method as defined in claim 15, including generating, by one or more of the at least one processor circuit, a synthetic image of scenery occluded.

20. The method as defined in claim 15, including guiding, by one or more of the at least one processor circuit, movement of the aircraft based on the estimated position.
